(19) United States
(12) Patent Application Publication
(10) Pub. No.: US 2009/0013309 A1
(43) Pub. Date: Jan. 8, 2009

(54) Generation of Custom Software Applications

(76) Inventor: Mark Shavlik, White Bear Lake, MN (US)

Correspondence Address: MERCHANT & GOULD PC, P.O. BOX 2903, MINNEAPOLIS, MN, 55402-0903, US

(21) Appl. No.: 11/966,739

(22) Filed: Dec. 28, 2007

Related U.S. Application Data
(60) Provisional application No. 60/877,857, filed on Dec. 29, 2006.

(51) Int. Cl. G06F 9/44

(52) U.S. Cl. 717/120

(57) ABSTRACT

A system for generating a custom software application is disclosed. The system includes an interface module programmed to generate an interface and configured to receive input. The system further includes a data generation module programmed to generate data defining operation of a custom software application in response to the input received through the interface. The system further includes an engine module programmed to generate the custom software application in response to the data generated by the data generation module. A method for generating a custom software application is also disclosed.

### RELATED APPLICATION

This application claims priority to U.S. Provisional Application No. 60/877,857 filed on Dec. 29, 2006, titled “GENERATION OF CUSTOM SOFTWARE APPLICATIONS,” the entire disclosure of which is hereby incorporated by reference in its entirety.

### TECHNICAL FIELD

The present disclosure relates to software applications, and more particularly to the generation of custom software applications.

### BACKGROUND

Users who need software tailored to particular needs are often faced with a dilemma. They must make do with off-the-shelf software that commonly has limited capabilities and is cumbersome to program. Alternatively, the users must develop their own custom software applications.

The problem is that developing a custom software application typically requires hiring trained experts to program the software application using complex programming languages. Due to the complexity of developing a custom software application, development can take a considerable amount of time, can consume a lot of resources, and is expensive. Furthermore, custom software applications are generally inflexible after they have been created. If subsequent modifications are needed, the user must again use trained experts to modify the software application.

### SUMMARY

In general terms, this patent is directed to a system having an engine for generating custom software applications based on a set of user-defined data. In one possible configuration and by non-limiting example, the set of data may be selected from a collection of data accessed over the Internet via a web browser.

One aspect is a system for generating a custom software application. The system comprises an interface module programmed to generate an interface. The interface is configured to receive input. A data generation module is programmed to generate data defining operation of a custom software application in response to the input received through the interface. An engine module is programmed to generate the custom software application in response to the data generated by the data generation module. The custom software application is executable by a programmable device.

Another aspect is a method for generating a custom software application. The method comprises: generating an interface configured to receive input; generating data, the data defining operation of a custom software application in response to the input received through the interface; and generating a custom software application in response to the data, the custom software application being executable by a programmable device.

Yet another aspect is a method of generating data defining a custom software application. The method comprises receiving user input; determining a text-based data command that corresponds with the user input; and storing the text-based data command in a data file, the data file being executable to generate a custom software application.

A further aspect is a method of executing a custom software application, the method comprising receiving a data file including at least one text-based data command defining the custom software application; determining a task associated with the text-based data command; and performing the task.

### BRIEF DESCRIPTION OF THE DRAWINGS

FIG. 1 is a flow diagram illustrating an example system for generating a custom software application according to the present disclosure.

FIG. 2 is a functional flow diagram of the system of FIG. 1.

FIG. 3 is a block diagram of an exemplary embodiment of a data generation module of the system shown in FIG. 1.

FIG. 4 is a block diagram of an exemplary embodiment of an engine module of the system shown in FIG. 1.

FIG. 5 is a block diagram of another exemplary embodiment of the engine module of the system shown in FIG. 1.

FIG. 6 is a functional block diagram of another exemplary embodiment of the engine module of the system shown in FIG. 1.

FIG. 7 is a block diagram of a programmable device capable of operating one or more modules of the system shown in FIG. 1.

FIG. 8 is a block diagram of an exemplary embodiment of the system shown in FIG. 1 including a single programmable device.

FIG. 9 is a block diagram of an alternate embodiment of the system shown in FIG. 1 including an administrator computer and a client computer.

FIG. 10 is a block diagram of an alternate embodiment of the system shown in FIG. 1 including an administrator computer and a client computer.

FIG. 11 is a block diagram of an alternate embodiment of the system shown in FIG. 1 including a web server and a computer connected to a network.

FIG. 12 is a block diagram of an alternate embodiment of the system shown in FIG. 1 including an add-on developer and a programmable device.

FIG. 13 is a block diagram of an alternate embodiment of the system shown in FIG. 10 including an add-on developer.

FIG. 14 is a block diagram of an alternate embodiment of the system shown in FIG. 1 including an add-on developer.

FIG. 15 is a flow diagram illustrating a method for generating a custom software application.

FIG. 16 is a flow diagram illustrating an operation for generating a user interface.

FIG. 17 is a flow diagram illustrating an operation for generating data.

FIG. 18 is a flow diagram illustrating an operation for generating a custom software application.

FIG. 19 is a flow diagram illustrating an alternate embodiment of the method of FIG. 15 for generating a custom software application.

FIG. 20 is a flow diagram illustrating an operation during which data defining a custom software application can be saved.

FIG. 21 is a block diagram illustrating an alternate application-specific embodiment of the system of FIG. 1 for generating a custom software application.

FIG. 22 is an example screen shot of a user interface for the system shown in FIG. 21.

FIG. 23 is an example screen shot of another user interface of the system of FIG. 21 displaying a first screen of options.

FIG. 24 is an example screen shot of the user interface shown in FIG. 23 displaying a second screen of options.

FIG. 25 is an example screen shot of a user interface of the system of FIG. 21 displaying a list of actions.

FIG. 26 is a screen shot of a user interface of the custom software application generated by the system shown in FIG. 21.

FIG. 27 is an example screen shot of another user interface of the system of FIG. 21 displaying a first screen of options.

FIG. 28 is an example screen shot of the user interface shown in FIG. 27 displaying a second screen of options.

FIG. 29 is an example screen shot of a user interface of the system of FIG. 21 displaying a list of actions.

FIG. 30 is a screen shot of a user interface of the custom software application generated by the system shown in FIG. 21.

FIG. 31 is an example screen shot of another user interface of the system of FIG. 21 displaying a first screen of options.

FIG. 32 is an example screen shot of the user interface shown in FIG. 31 displaying a second screen of options.

FIG. 33 is an example screen shot of a user interface of the system of FIG. 21 displaying a list of actions.

FIG. 34 is a screen shot of a user interface of the custom software application generated by the system shown in FIG. 21.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The logical operations of the various embodiments of the invention described herein are implemented as: (1) a sequence of computer implemented operations running on a computing system; and/or (2) interconnected machine modules within the computing system. Modules represent functions executed by program code such as commonly available programming languages. The implementation used is a matter of choice dependent on the performance requirements of the particular programmable device, and associated computing systems. Accordingly, the logical operations making up the embodiments of the invention described herein can be referred to alternatively as operations, modules, and the like.

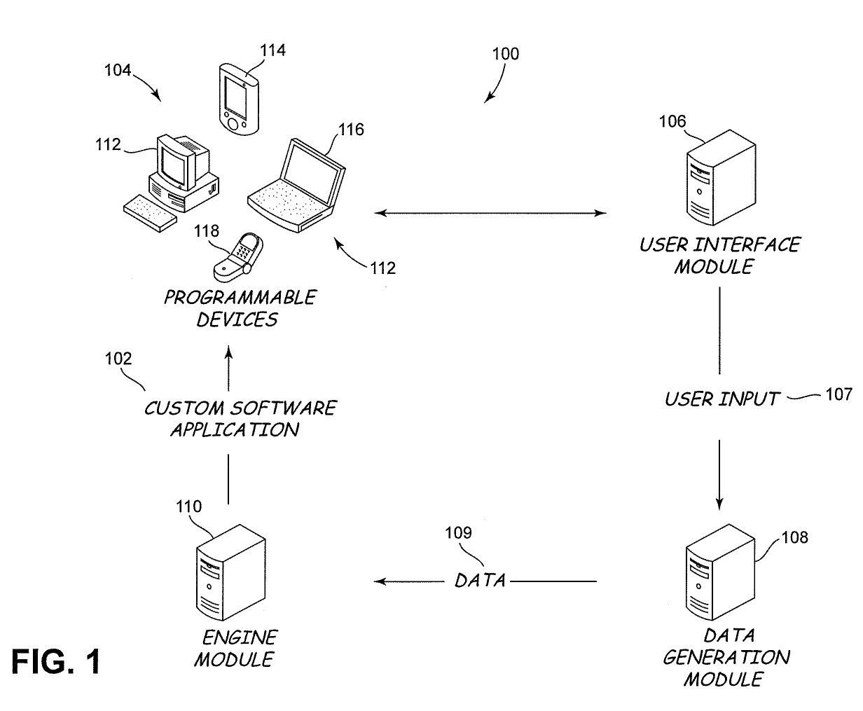

FIG. 1 is a flow diagram illustrating a possible embodiment of system 100 for generating a custom software application 102 according to the present disclosure. System 100 includes programmable devices 104, user interface module 106, data generation module 108, and engine module 110. Programmable devices 104 include, for example, personal computer 112, personal digital assistant (PDA) 114, laptop computer 116, a cell phone 118, or any other programmable device. Other possible examples include an automobile, a television, an entertainment system, a watch, a medical device, a video game system, and a java ring. A user can interact with one of programmable devices 104 to define and generate custom software application 102 that will operate on that programmable device 104 or on another programmable device 104. Programmable devices 104 are capable of communicating with or executing user interface module 106.

In an exemplary embodiment, user interface module 106 interacts with one or more programmable devices 104 to present a user interface to the user. In another exemplary embodiment, the user interface module 106 enables a user to define the operation of a custom software application without requiring the user to have any specialized knowledge or training in the development of custom software applications. Other embodiments require some level of specialized knowledge or training in the development and/or programming of custom software applications. User interface module 106 first presents a user interface to the user (such as via a display). User interface module 106 then receives input from the user that defines the desired operation of the custom software application 102. User interface module 106 communicates user input 107 to data generation module 108.

Data generation module 108 generates data 109 based on the input received from the user. Data 109 includes instructions that are subsequently used to generate custom software application 102. The data 109 generated by data generation module 108 is, for example, an ordered and structured text-based language. In another possible embodiment, data 109 is a syntactical and semantical text-based language such as extensible markup language (XML). Data generation module 108 is capable of communicating the data 109 to engine module 110.

Engine module 110 is capable of generating a custom software application in response to data 109 generated by the data generation module 108. In this exemplary embodiment, the custom software application is formed from the combination of the data 109 and the engine module 110. For example, the engine module 110 receives the data 109 and designates or enables certain API calls that correspond to the data 109. During execution of the custom software application the API calls corresponding to the data 109 are selectively passed to the operating system. In this way, custom software application 102 is generated by engine module 110 in response to the data 109 to provide the specific features and functionality desired by the user of a programmable device 104. In another embodiment, engine module 110 generates a custom software application that is an executable program that is executable independent of engine module 110.

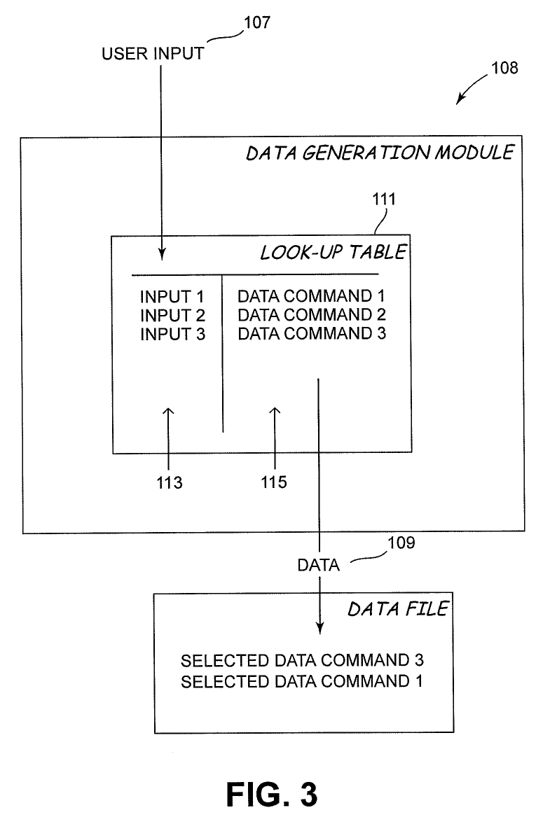

System 100 is shown in FIG. 1 with each of modules 106, 108, and 110 located on a separate device. In other possible embodiments, system 100 is configured with other system or network configurations. Some possible system and network configurations are illustrated in FIGS. 3-12. In one embodiment, modules 106, 108, and 110 are all operated on one of the programmable devices 104. In another embodiment, two of modules 106, 108, and 110 are operated on one programmable device 104, and the other module is operated on another programmable device. Therefore, one of the benefits of system 100 is that system 100 is capable of matching an existing system or network configuration, rather than the system or network configuration being required to conform to a specific structure of system 100.

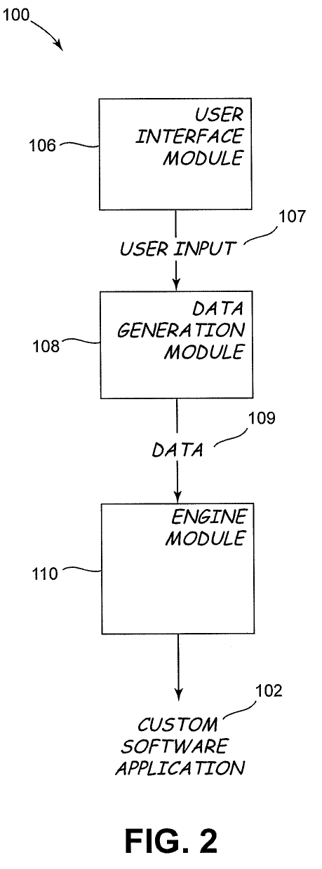

FIG. 2 is a functional block diagram of system 100 for generating custom software application 102. System 100 includes user interface module 106, data generation module 108, and engine module 110. User interface module 106 receives and passes user input 107 to data generation module 108. Data generation module generates data 109 and passes data 109 to engine module 110. Engine module 110 generates the custom software application based on data 109.

In an exemplary embodiment, user interface module 106 conveys information to a user and receives input from the user. In another embodiment, user interface module 106 is a Web browser. A web page is displayed to the user through the Web browser. The web page presents the user with a set of options representing the available features and functions of custom software application 102. The user selects from the set of options with an input device, such as a keyboard or a mouse, to define the desired operation of custom software application 102. In selecting from the set of options, the user establishes the set of data parameters 109 defining how the custom software application will operate and how the custom software application will interact with the user.

In another possible embodiment, user interface module 106 is a computer program that displays a user interface on a computer monitor. The computer program is executed by the computer to display the user interface on the computer monitor with a set of options representing the available features and functions for custom software application 102. The user selects from the set of options with an input device, such as a keyboard or a mouse, to define the desired operation of custom software application 102.

In another possible embodiment, user interface module 106 is an audio system such as in an automobile. The audio system presents to the user, such as through a speaker, a set of options representing the available features and functions of custom software application 102. The user selects from the set of options, such as by speaking into a microphone, to define the desired operation of custom software application 102. For example, user interface module 106 includes a voice recognition module. The voice recognition module receives a modulated signal from a microphone. The modulated signal is processed by the voice recognition module to convert the signal into commands that are then stored as user input. Alternatively, the user responds to the audible options by manually entering user input into a programmable device, such as through a keyboard, mouse, touch screen, touch pad, or other input device.

In another possible embodiment, user interface module 106 is a software application operating on a cell phone, personal digital assistant, tablet PC, laptop computer, medical device, or other portable system having a display. User interface module 106 displays a user interface on the display to present a set of options representing the available features and functions of custom software application 102 to the user. The user selects from the set of options, such as by pressing buttons on the portable system or by pressing against a touch screen. The selections define the desired operation of custom software application 102.

In another possible embodiment, user interface module 106 is an interface module that receives input from another programmable device, rather than a user. The interface module generates an interface capable of being understood by the programmable device, and receives input from the programmable device defining the desired operation of a custom software application.

Data generation module 108 is a system capable of receiving user input 107 from user interface module 106 and generating data 109 based on user input 107. In one embodiment, data generation module 108 is a software application operating on a programmable device 104. The software application receives user input 107 and generates data 109 that defines the desired operation of custom software application 102. One of the benefits of system 100 being driven by data 109 is that data 109 can be generated by data generation module 108 without regard to any particular operating system. In this respect, data generation module 108 and data 109 are platform independent.

In one embodiment, data 109 is a structured arrangement of text, written in a syntactical and semantical language (SSLANG). For example, data 109 is a text-based language formed exclusively of notations including letters, numbers, and symbols such as those represented by American Standard Code for Information Interchange (ASCII). In another embodiment, data 109 is formed exclusively of notations including those capable of being represented by Unicode Transformation Format (UTF), such as UTF-8. In another embodiment the data is formed with a markup language such as XML. Data 109 can also include additional notations beyond those identified herein.

In one embodiment, data 109 is structured to define a set of objects having attributes, and also a set of actions associated with the objects. A number of specific examples illustrating the composition and makeup of data 109 are provided below with reference to the application-specific examples.

Engine module 110 is a system capable of generating custom software application 102 based at least in part on data 109. In one embodiment, engine module 110 is a software application operating on a computer. In another embodiment, engine module 110 is a software application operating on a programmable device 104. Engine module 110 receives data 109 from data generation module 108 and reads data 109. Engine module 110 determines the user's desired operation of custom software application 102 by reading data 109 and then generates custom software application 102 accordingly. In one embodiment, engine module 110 generates custom software application 102 by passing application programming interface (API) calls to the operating system. The API calls are determined in response to the options selected by the user through the user interface generated by user interface module 106. As a result, engine module 110 is generally platform specific and designed to interface with a particular operating system. However, in another embodiment, engine module 110 is configured to operate under more than one operating system, such as by including API calls for multiple operating systems.

Some operating system developers, such as Microsoft, make public most if not all of their API information. In addition, some APIs that are not made public can be reverse engineered to provide additional functionality. Engine module 110 includes API calls for desired system functions. In one embodiment, engine module 110 is capable of utilizing all services of an operating system. This embodiment is referred to as a complete representation of the operating system. In another embodiment, engine module 110 is limited to only those services most likely to be needed, thereby reducing the storage cost and complexity of engine module 110.

In one embodiment, engine module 110 is a translator. Engine module 110 receives data 109 including a text-based language, and translates data 109 into commands, such as API calls, that can be passed to the operating system to generate custom software application 102. This may be performed by engine module 110 such as through a look-up table, through a coded software algorithm, through rules, or the like.

In another embodiment, engine module 110 is supplemented with a second engine module. In this embodiment, engine module 110 is used to process instructions in data 109, but a second engine module is used to process code. An example of an engine that processes code is a C# interpreter, capable of processing C# code and C++ code. The C# engine and engine module 110 are capable of functioning together to generate a custom software application by processing both data 109 and supplemental code. In an alternate embodiment, the second engine module is the Microsoft®.NET brand connection software. One of the benefits of the dual engine system is that features or functions beyond those defined by user interface module 106 can be included in a custom software application. On the other hand, the embodiment in which engine module 110 generates custom software application 102 based solely on data 109 has the benefit of not requiring the user to write any programming language code, and therefore requires no specialized skill or training.

In another possible embodiment, engine module 110 generates a custom software application 102 that is executable by a programmable device independent of engine module 110. In this embodiment, the custom software application is generated by engine 110 which is capable, itself, of making API calls to the operating system that correspond to the instructions of data 109.

In possible embodiments, custom software application 102 operates to perform tasks as defined by the user through user interface module 106, and as defined by data 109. In this way, the user is no longer required to settle for off-the-shelf software applications having limited functionality. In addition, the user no longer has to incur the large expense of hiring developers to code a custom software application. Furthermore, the custom software application is defined and generated on-demand in a matter of moments, rather than in days, weeks, or months as is generally required to custom code, compile, test, and debug a custom software application.

Custom software application 102 exists, in an exemplary embodiment, only so long as it is being generated by engine module 110. After custom software application 102 has completed its intended purpose, it is terminated and ceases to exist. In this way, valuable resources are released back to the system for the operation of other systems or services. If desired, data 109 can be saved to reuse or modify a custom software application without requiring that it be completely redefined through user interface module 106.

FIG. 3 is a block diagram of an exemplary embodiment of data generation module 108. Data generation module 108 includes a software algorithm that utilizes look-up table 111. In this example, look-up table 111 includes an input column 113 and a data command column 115. Each input identified in input column 113 is associated with a data command in data command column 115.

In one embodiment, a data command is a structured arrangement of text, written in a syntactical and semantical language. For example, some embodiments include text-based data commands. Text-based data commands are formed exclusively of notations including letters, numbers, and symbols such as those represented by American Standard Code for Information Interchange (ASCII). In another embodiment, data commands are formed exclusively of notations including those capable of being represented by Unicode Transformation Format (UTF), such as UTF-8. In another embodiment data commands are formed with a markup language such as XML. Other embodiments use data commands based on other notations or programming commands beyond those specifically identified herein.

Data generation module 108 receives a set of user inputs 107 from user interface module 106. Selection of user input 107 is discussed in more detail herein. In one embodiment, user input 107 is received that corresponds to selected objects on a graphical user interface. For example, user interface module 106 includes a web browser that displays the graphical user interface as a form to the user. The user selects from various objects displayed on the form to identify the desired options for the custom software application. The selected user input is submitted to data generation module 108 by a mechanism such as an HTTP get or put message. The message includes the set of user inputs 107 in the message body.

Once data generation module 108 has received the set of user inputs 107, data generation module 108 parses the user input. In one embodiment, each user input is read individually. The user input is then matched with the same user input located in input column 113 of look-up table 11. Once found, data generation module 108 then determines the associated data command in data command column 115. The data command is then stored for subsequent delivery to engine module 110, such as in a data file. Data generation module 108 continues to read in each user input and identify the corresponding data command until all user input has been processed.

For example, a first user input 107 is read by data generation module 108 that corresponds with “input 3.” Data generation module 108 determines that “data command 3” is associated with “input 3” and stores the selected “data command 3” in the data file. A second user input 107 is then read by data generation module 108 that corresponds with “input 1.” Data generation module 108 determines that “data command 1” is associated with “input 1” and stores the selected “data command 1” in the data file.

Other embodiments of data generation module 108 operate using mechanisms other than, or in addition to, a look-up table. For example, one possible embodiment implements a look-up table programmatically, such as using IF/THEN statements or other programmatic algorithms.

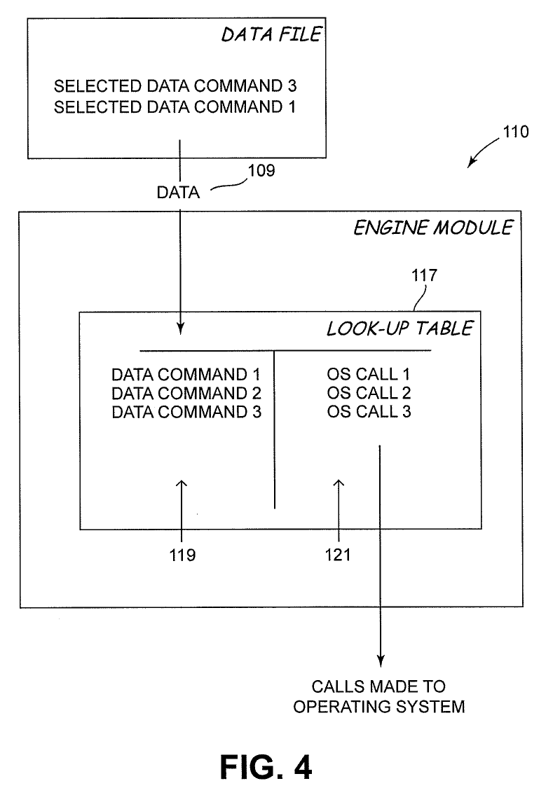

FIG. 4 is a block diagram of an exemplary embodiment of engine module 110. Engine module 110 includes a software algorithm that utilizes look-up table 117. In this example, look-up table 117 includes a data command column 119 and an operating system (OS) call column 121. Each data command identified in data command column 119 is associated with one or more operating system calls in operating system call column 121.

Engine module 110 receives data 109 including a set of data commands from data generation module 108. In one embodiment, data 109 is XML data. In some embodiments, data 109 is communicated to engine module 110 using a communication protocol such as HTTP.

In some embodiments, engine module 110 parses the data commands to begin execution of the custom software application. Engine module 110 reads a first data command from data 109 and locates that data command in data command column 119. Once located, engine module 110 then determines the operating system call of operating system call column 121 that is associated with the data command. Once engine 110 has determined the associated operating system call, engine 110 communicates the call to the operating system. The operating system then performs the task or routine identified by the operating system call to execute a portion of the custom software application.

For example, engine module 110 reads the first data command from the data file. The first data command is selected “data command 3.” Engine module 110 matches the selected “data command 3” with “data command 3” in column 119 and determines that “Operating System call 3” corresponds to the data command. As a result, engine module 110 makes the identified call to the operating system. The next data command is then read from the data file, which is selected “data command 1.” The engine module 110 determines that “data command 1” corresponds to “Operating System call 1”. Engine module 110 then makes the identified call to the operating system.

One example of an operating system call is an Application Programming Interface (API) call, such as available for use with the Windows® operating system distributed by Microsoft Corporation of Redmond, Wash. Other operating system calls are used in other embodiments.

Other embodiments of engine module 110 operate differently. For example, one possible embodiment implements a look-up table programmatically, such as using IF/THEN statements or other programmatic algorithms.

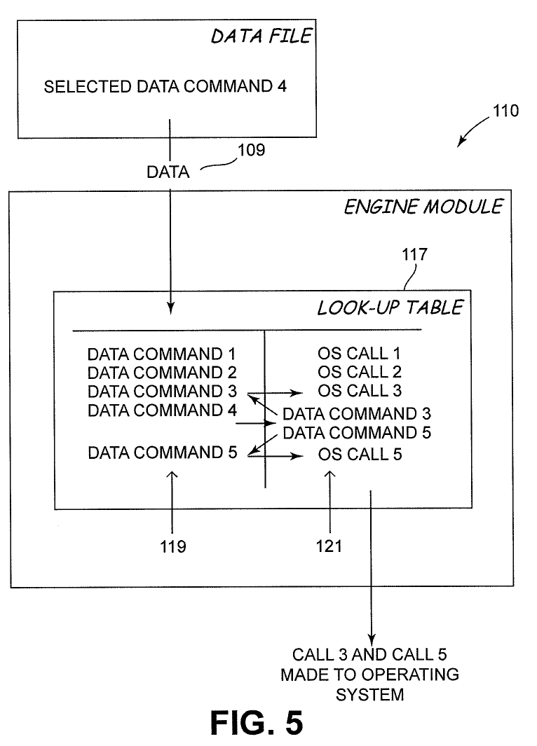

FIG. 5 is a block diagram of an alternative embodiment of engine module 110 including look-up table 117. In this embodiment, the data commands 119 are associated with one or more other data commands 119. For example, “data command 4” (in data column 119) is associated with “data command 3” and “data command 5” in operating system call column 121. When data 109 is read, selected “data command 4” is identified. Engine module 110 uses look-up table 117 to determine that “data command 4” is associated with “data command 3” and “data command 5.” Engine module 110 then uses look-up table 117 to locate “data command 3.” Engine module 110 determines that “data command 3” is associated with “operating system call 3”, and therefore makes that call to the operating system. Engine module 110 then uses look-up table 117 to locate “data command 5.” Engine module 110 determines that “data command 5” is associated with “operating system call 5” and makes the appropriate call to the operating system.

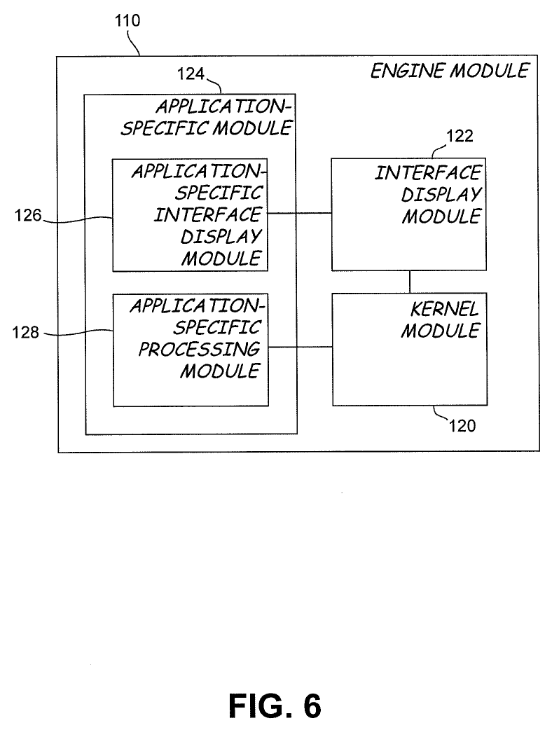

In this way, a single data command from data 109 can be used to request multiple operating system functions. This nesting capability is further illustrated with reference to FIG. 6 below.

In the example described herein, the engine module executes the custom software application dynamically, as it receives the data file. However, in alternate embodiments engine module 110 saves a file for later execution of the custom software application. As one example, engine module 110 generates an executable file that is later executed by a programmable device. As another example, engine module 110 sends the data file to another engine module that executes the custom software application. As yet another example, engine module 110 saves the data file for execution at a later time.

FIG. 6 is a block diagram of an exemplary embodiment of engine module 110. Engine module 110 includes kernel module 120, interface display module 122, and application-specific module 124. Application-specific module 124 includes application-specific interface display module 126 and application-specific processing module 128. Engine module 110 operates to generate custom software application 102, such as illustrated in FIG. 1.

Kernel module 120 is capable of communicating with the operating system to perform the lowest-level operation of engine module 110. Kernel module 120 operations include file system operations, random access memory (RAM) and disk drive operations, printing operations, network communication operations, logging operations, user interface support operations, repository/registry operations, system security operations, performance monitoring operations, and other low-level functions. Kernel module 120 is the core of engine module 110, and provides the building block upon which additional modules can be added.

In some embodiments, kernel module 120 identifies a base set of data commands and operating system calls for an engine look-up table, such as look up table 117 (shown in FIG. 5).

Interface display module 122 adds to the functionality of kernel module 120, by providing additional capabilities for interface display operations. Interface display module 122 operations include window display operations, menu display operations, tree control operations (such as for standard file system displays), and other standard displays or controls. Interface display module 122 utilizes features provided by kernel module 120, such as the user interface support operations. Alternate embodiments include operations in addition to graphical displays, such as generating audible sounds, generating tactile sensations, or otherwise conveying information to a user.

In some embodiments, interface display module 122 provides additional data commands and operating system calls that the engine module 110 stores in look-up table 117. The commands and operating system calls build upon those provided by kernel module 120. For example, a data command provided by interface display module 122 may refer to one or more data commands provided by kernel module 120.

In an exemplary embodiment, a desired custom software application is generated based solely upon kernel module 120 and interface display module 122, because all or nearly all operating system capabilities can be accessed with these modules. However, the task of defining such a custom software application based solely on these modules would be time consuming and difficult because the entire custom software application would have to be defined from low-level pieces. Another exemplary embodiment reduces or eliminates the requirement of using low-level pieces by providing additional modules that provide pre-defined groupings of tasks based upon kernel module 120 and interface display module 122. For this purpose, one or more application-specific modules 124 are installed into engine module 110.

Application-specific modules 124 include application-specific interface display module 126 and application-specific processing module 128. Application-specific modules 124 provide predefined features and functionality specially tailored to meet the needs of a particular group of users. Application-specific interface display module 126 adds to interface display module 122, and provides predefined interface displays that are customized for a particular application. Application-specific processing module 128 adds to kernel module 120 to provide more complex predefined processing operations that are customized for the particular application.

In some embodiments, application-specific modules 124 provide additional data commands and operating system call that engine module 110 stores in look-up table 117. The commands and operating system calls build upon those provided by kernel module 120, and optionally build upon those provided by interface display module 122 or other modules. For example, a data command provided by an application-specific module 124 may refer to one or more data commands provided by kernel module 120. Those data commands may also refer to one or more other data commands, and so on, until the complete set of operating system calls needed to perform a particular task have been identified by engine module 110.

Any group that shares a common job function, role, task, industry, or any other characteristics can benefit from an application-specific module 124. A few applications for an application-specific module include computer security, anti-malware, compliance, systems administrator, hospital administrator, and data management. However, applications also can be defined much more broadly, for example, to include all personal computer users, or much more narrowly to include only a single user.

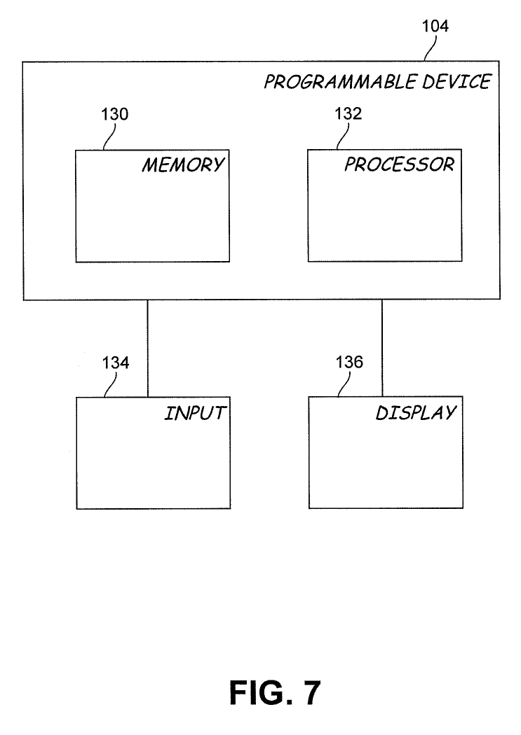

FIG. 7 is a block diagram of programmable device 104 capable of operating one or more of user interface module 106, data generation module 108, engine module 110, and custom software application 102. Programmable device 104 includes memory 130 and processor 132. Memory 130 is any type of digital storage including random access memory (RAM), read-only memory (ROM), a hard disc drive, a floppy disc drive, a compact disc (CD) ROM, a CD rewritable (RW), a Digital Versatile Disc (DVD) ROM, DVD RAM, or any other type of digital storage. Processor 132 is a microprocessor, central processing unit, or any other type of digital processor. In another embodiment, processor 132 includes memory 130.

Programmable device 104 is capable of receiving an input from input device 134. Input device 134 is a keyboard, mouse, joystick, touch pad, microphone, or any other device capable of receiving an input from a user. Programmable device 104 is capable of conveying information to a user through an output device such as display 136. Display 136 is a computer monitor, television, liquid crystal display, or any other device capable of displaying information to a user. In an alternate embodiment, programmable device 104 conveys information to a user through a speaker, buzzer, vibrator, or other output device.

Various embodiments of system 100 will now be described to illustrate some of the possible hardware and/or network configurations of system 100. These non-limiting examples are provided to illustrate the flexible design capabilities of system 100, enabling system 100 to conform to nearly any desired hardware or network configuration.

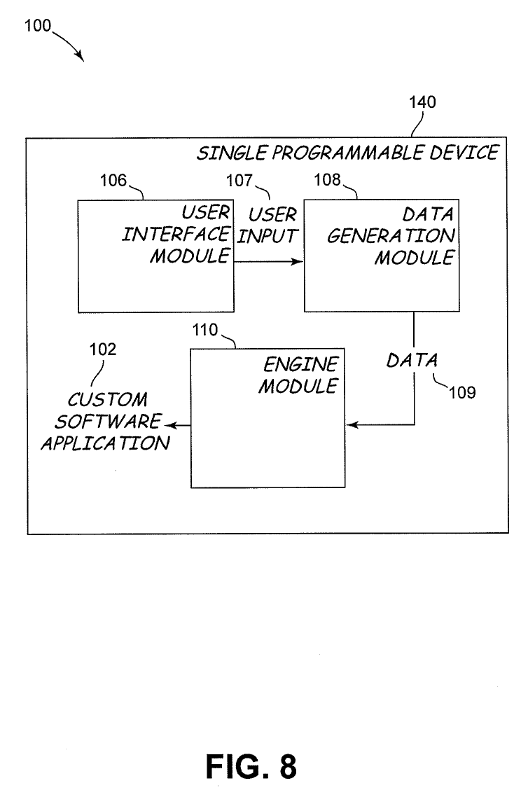

FIG. 8 is a block diagram of an exemplary embodiment of system 100 including single programmable device 140. Programmable device 140 is, for example, a computer. Programmable device 140 includes user interface module 106, data generation module 108, and engine module 110. User interface module 106 is a software application that displays a user interface to a user on a computer monitor. The user provides user input 107, such as through a keyboard and a mouse, which is sent from user interface module 106 to data generation module 108. Data generation module 108 is a computer program that receives the user input 107 from user interface module 106, generates data 109 based on the user input, and sends the data to engine module 110. Engine module 110 receives the data 109 and generates custom software application 102.

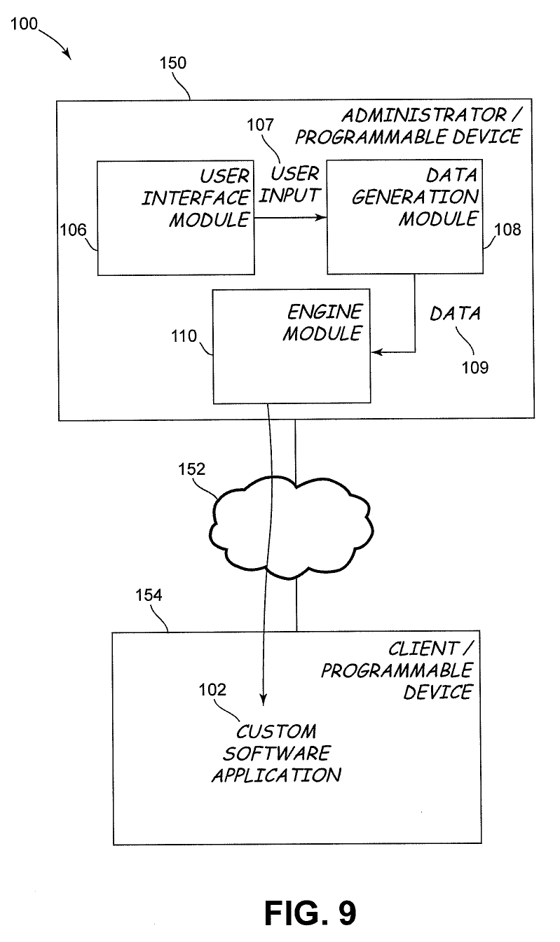

FIG. 9 is a block diagram of an alternate embodiment of system 100 including programmable devices 150 and 154 connected across network 152. In this embodiment, programmable device 150 is an administrator's computer, and programmable device 154 is a client computer. An administrator interacts with programmable device 150 to define a custom software application 102 to be operated on programmable device 154.

User interface module 106 receives input from the administrator to define the desired operation of custom software application 102. User input 107 is passed to data generation module 108, which generates data 109, and passes the data to engine module 110. Engine module 110 generates custom software application 102 on the remote client/programmable device 154. In one example, custom software application 102 is generated on programmable device 154 by sending remote API calls across network 152 to the operating system of programmable device 154. One of the benefits of this embodiment, is that custom software application 102 can be generated on programmable device 154 even though no special software or modules have been installed on it. So long as programmable device 154 has an operating system capable of receiving and responding to remote API calls, custom software application 102 is operable on programmable device 154 from remote engine module 110.

In one embodiment, programmable device 150 operates as an application service provider (ASP). The ASP charges a subscription fee to the owner of programmable device 154 in exchange for the benefit of one or more services provided by programmable device 150. For example, a subscription is purchased to programmable device 150 providing computer security services. After the subscription has been purchased, programmable device 150 executes one or more custom software applications on programmable device 154 to provide computer security services.

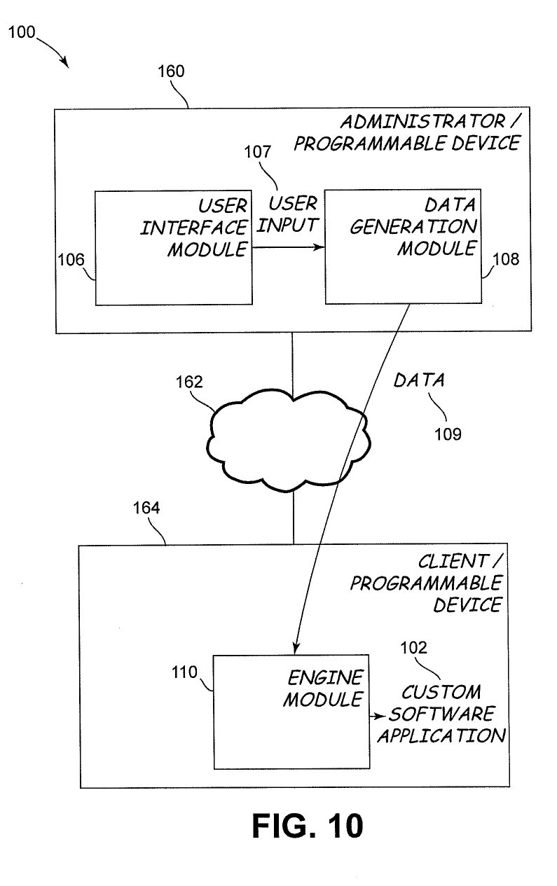

FIG. 10 is a block diagram of an alternate embodiment of system 100 including programmable devices 160 and 164 connected across network 162. In this example, programmable device 160 is an administrator's computer and programmable device 164 is a client computer. User interface module 106 presents a user interface to the administrator and receives input from the administrator to define the operation of a custom software application 102. The user input is passed to data generation module 108, which generates data 109 based upon user input 107.

In this embodiment, data generation module 108 sends data 109 to engine module 110 of programmable device 164 across network 162. Communication between data generation module 108 and engine module 110 can be any form of network communication, including hypertext transfer protocol (HTTP), secure socket layer (SSL) protocol, Transfer Layer Security (TLS) protocol, or other methods of data communication. In an alternate embodiment, communication occurs through infrared communication, or over a network using infrared communication. In an alternate embodiment, communication occurs using wireless data communication, such as in a wireless network. In an alternate embodiment, communication occurs through satellite radio, such as an XM radio network. Engine module 110 receives data 109 and generates custom software application 102 on programmable device 164.

In an alternate embodiment, network 162 is not required, and data transfer can occur manually by a user. For example, data 109 can be stored on a digital medium such as a flash ROM from programmable device 160. The digital medium is physically transferred and connected to programmable device 164 where it data 109 is transferred to engine module 110.

In an alternate embodiment, a third programmable device is included in system 100 and connected to network 162. Engine module 110 operating on programmable device 164 generates the custom software application, but causes it to run on the third programmable device. This is accomplished, for example, using remote API calls to the third programmable device across the network.

Various business models are possible through this and other embodiments of system 100. In one embodiment, engine module 110 is purchased by the owner of programmable device 164 from programmable device 160 prior to downloading. In another embodiment, a trial period is provided for engine module 110, after which engine module 110 must be purchased for continued use. In another embodiment, engine module 110 is freely distributed, but a subscription fee is charged to receive services from programmable device 160.

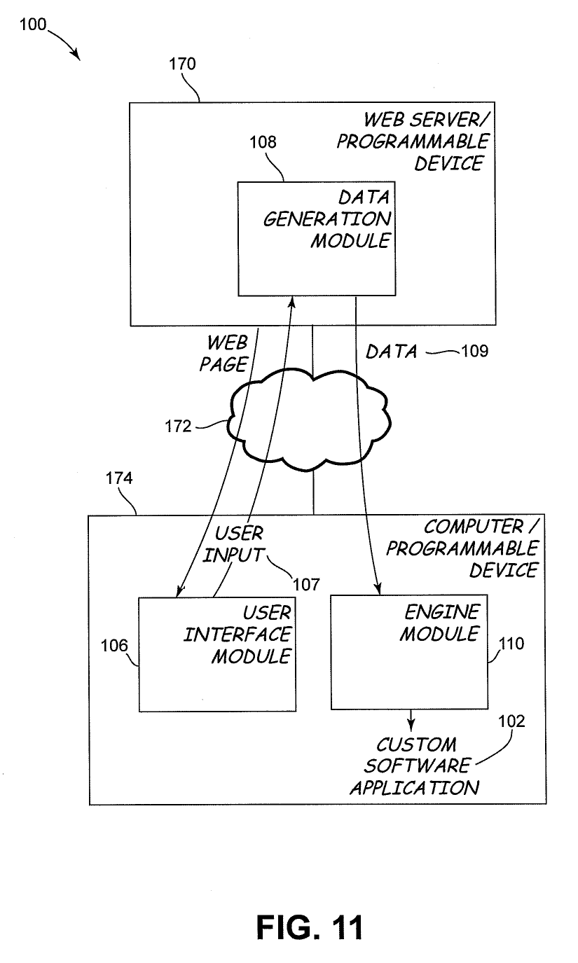

FIG. 11 is a block diagram of an alternate embodiment of system 100 including programmable device 170 and 174 connected across network 172. In this example, programmable device 170 is a web server and programmable device 174 is a network-connected computer or other programmable device such as a wireless handheld device. Network 172 is a network, such as the Internet or an Intranet.

In this example, user interface module 106 is a web browser located on programmable device 174. User interface module 106 displays a user interface to the user of programmable device 174 by displaying a web page received from programmable device 170 on a computer screen or other display. The web page is encoded in hypertext markup language (HTML) and is sent over network 172 using HTTP. The web browser displays the user interface to the user and receives user input 107 to define a desired custom software application. The user input is sent back to programmable device 170, such as through HTTP across network 172. Data generation module 108 receives user input 107 from programmable device 174, and generates data 109 based on user input 107. Data 109 is then passed to engine module 110 across network 172.

If engine module 110 has not yet been installed on programmable device 174, the web page received from web server 170 includes an option to download engine module 110. If selected by the user, engine module 110 is downloaded and installed onto programmable device 174. For example, engine module 110 is a browser plug-in. Alternatively, engine module 110 is a separate software application.

Once engine module 110 has been installed on programmable device 174, custom software application 102 is generated by engine module 110 based on data 109. Custom software application 102 runs on programmable device 174 to provide the features and functionality desired by the user of programmable device 174.

Various business models are possible through this and other embodiments of system 100. In one embodiment, the user purchases copies of user interface module 106 and of engine module 110. In another embodiment, the user purchases copies of engine module 110, but uses any web browser for user interface module 106. In another embodiment, engine module 110 is freely distributed, but a subscription fee is charged to access web server 170. For example, a username and password can be required to access the web page provided by web server 170.

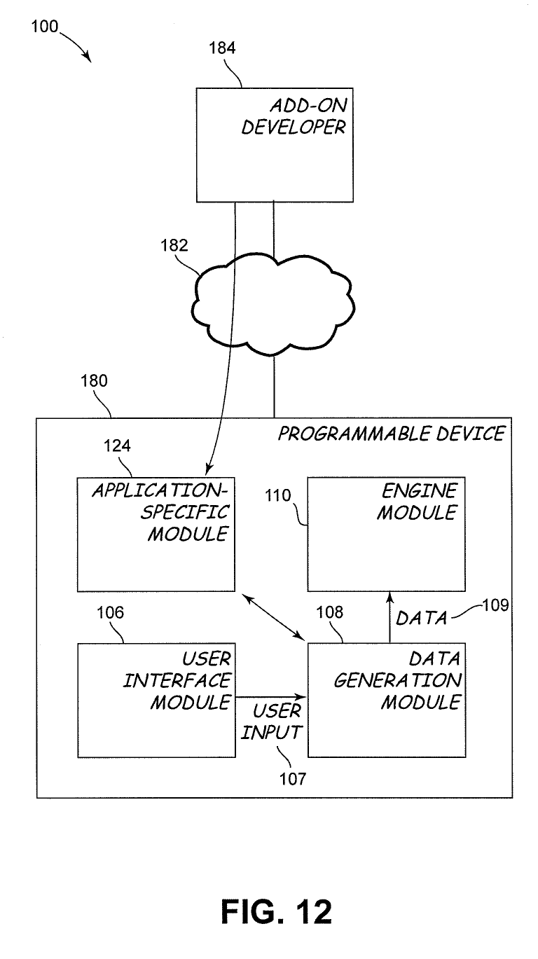

FIG. 12 is a block diagram of an alternate embodiment of system 100 including an add-on developer 184. In FIG. 6, an application-specific module 124 was described which added application-specific functionality to engine module 110. System 100, illustrated in FIG. 12, shows one embodiment of a system including add-on developer 184 who develops and distributes application-specific module(s) 124 for developing a particular type of custom application. Examples include application-specific modules for developing custom software applications relating to computer security, anti-malware, compliance, systems administration, hospital administration, and data management.

In another exemplary embodiment, add-on developer 184 also provides an application-specific user interface through user interface module 106. In one example, add-on developer 184 provides a data schema file that can be used by interface module 106 to generate the application-specific user interface.

In the illustrated embodiment, system 100 includes a single programmable device 180 and an add-on developer 184, connected across network 182. Programmable device 180 includes user interface module 106, data generation module 108, engine module 110, and application-specific module 124.

Add-on developer 184 provides application-specific modules 124 that simplify the development of a custom software application. Application-specific module 124 is installed on programmable device 180, such as by downloading it from add-on developer 184 via the Internet, installing it from a CD-ROM, or by any other method of installing software onto programmable device 180.

Add-on developer 184 also provides to programmable device 180 information about the functionality provided by application-specific module 186. In one example, this information is provided in the form of a data file referred to as a data schema file. The data schema file defines all of the features or functions made available through application-specific module 124. User interface module 106 uses the data schema file to present to the user an application-specific set of options which simplifies the process of defining a custom software application. The custom software application can then be quickly and easily defined by a user by selecting from the set of options.

As described above with reference to FIG. 6, application-specific module 124 operates in cooperation with engine module 110 to provide additional processing and/or user interface capabilities. In one embodiment, a task defined by application-specific module 124 is a group of tasks that are performed by engine module 110. In another embodiment, tasks defined by application-specific module 124 include tasks performed by engine module 110, but also include additional tasks.

Application-specific modules typically reduce the amount of data 109 that must be passed to engine module 110 to generate a custom software application. Application-specific module 124 provides the capability of grouping a potentially complex set of tasks into a single task with a single instruction, thereby allowing a potentially complex set of tasks to be referenced in data 109 by a single word or command. For example, to display a list of computers using engine module 110 alone could require many commands, including opening a file, reading the list of computers from the file, displaying a window, displaying a scroll bar, displaying the first computer name, displaying the second computer name, etc. However, the same set of tasks could be defined by a single “List Computers” command with the addition of an appropriate application-specific module 124, thereby greatly reducing the complexity of data 109.

In an exemplary business model, add-on developers charge a user to purchase application-specific module 124 from add-on developer 184. In an another exemplary embodiment, add-on developers charge a subscription fee. In exchange for the subscription fee, the add-on developer provides occasional updates of application-specific module 124 to programmable device 180. In other exemplary embodiments, these or similar business models are used in conjunction with other system or network configurations.

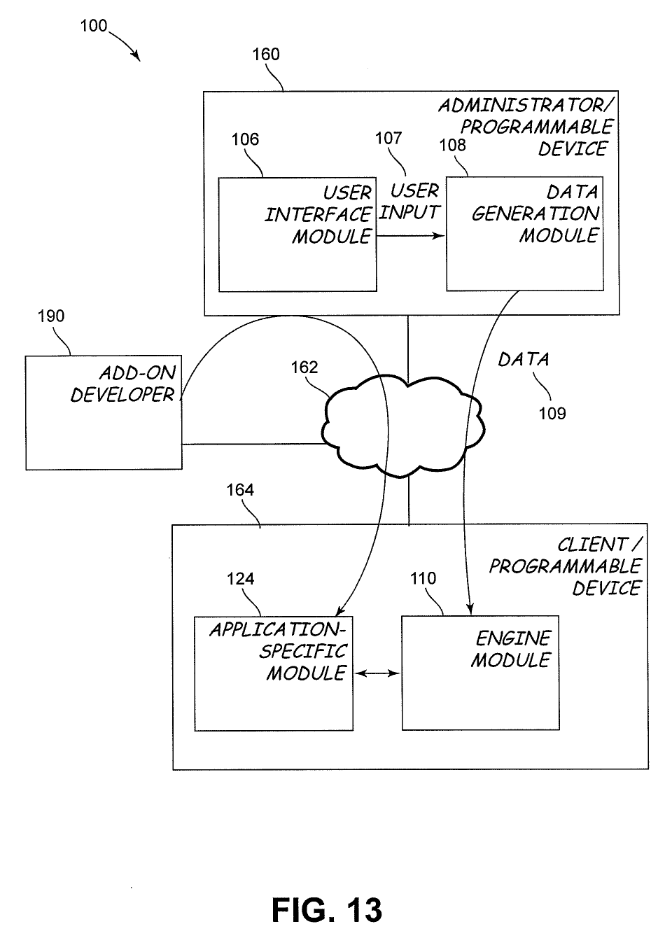

FIG. 13 is a block diagram of an alternate embodiment of system 100 including add-on developer 190. This embodiment is the same as the embodiment illustrated in FIG. 10, except for the addition of add-on developer 190 and application-specific module 124. System 100 includes administrator/programmable device 160, network 162, and client/programmable device 164.

Application-specific module 124 is provided by add-on developer 190 to administrator 160. Administrator 160 downloads a copy of application-specific module 124 from add-on developer 190 and then copies application-specific module 124 to client 164. Alternatively, application-specific module 124 is downloaded by a user of client 164 directly from add-on developer 190. Alternatively, application-specific module 124 is installed on client 164 directly from digital media received from add-on developer, such as from a CD-ROM. Application-specific module 124 operates in cooperation with engine module 110 to generate an application-specific custom software application on client 164.

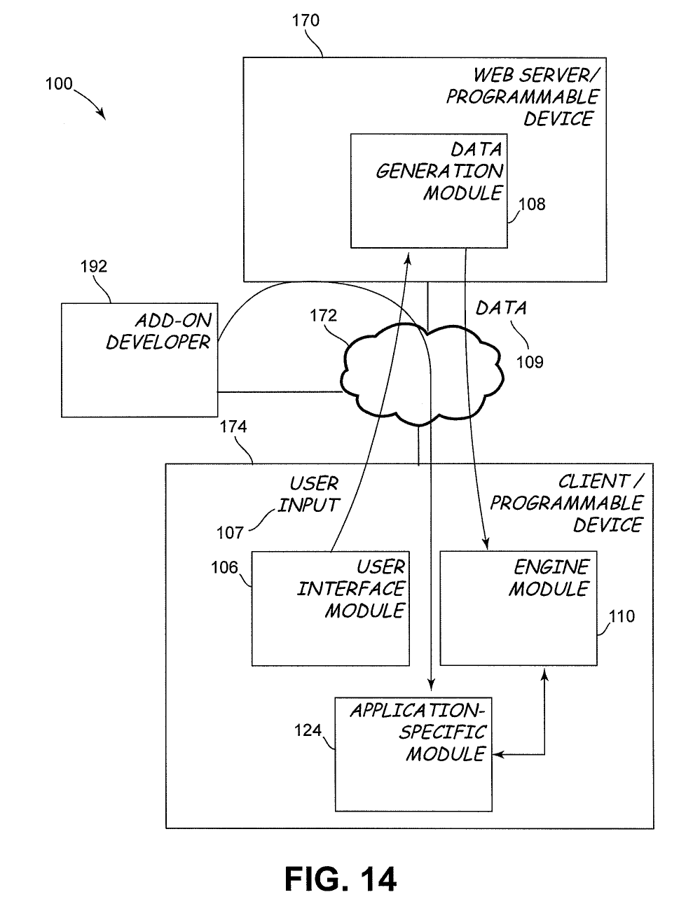

FIG. 14 is a block diagram of an alternate embodiment of system 100 including add-on developer 192. This embodiment is the same as the embodiment illustrated in FIG. 11, except for the addition of add-on developer 192 and application-specific module 124. System 100 includes web server 170, network 172, and computer 174.

Application-specific module 124 is developed by add-on developer 192 for use with engine module 110. Add-on developer 192 makes application-specific module 124 available to either web server 170 or computer 174. If provided to web server 170, web server 170 includes an option via a web site to download application-specific module 124 to computer 174. Application-specific module 124 operates in cooperation with engine module 110 to generate an application-specific custom software application on client 174.

In addition to the specific embodiments shown above, it should be apparent that application-specific modules can be used in any system or network configuration. In addition, some possible embodiments have application-specific module 124 and engine module 110 located on separate programmable devices. In this embodiment, communication occurs between the modules to generate the custom software application, such as across a network.

Modules operate to perform a particular function of system 100. Modules, as shown in FIG. 1, include user interface module 106, data generation module 108, and engine module 110.

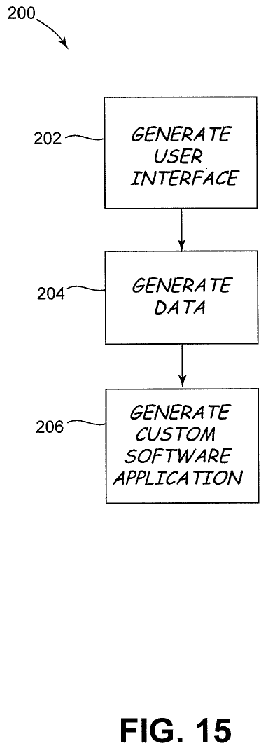

FIG. 15 is a flow diagram illustrating method 200 for generating custom software application 102. Method 200 includes operation 202 during which a user interface is generated, operation 204 during which data is generated, and operation 206 during which a custom software application is generated based on the data. Each of operations 202, 204, and 206 are further illustrated and described with reference to FIGS. 13-17.

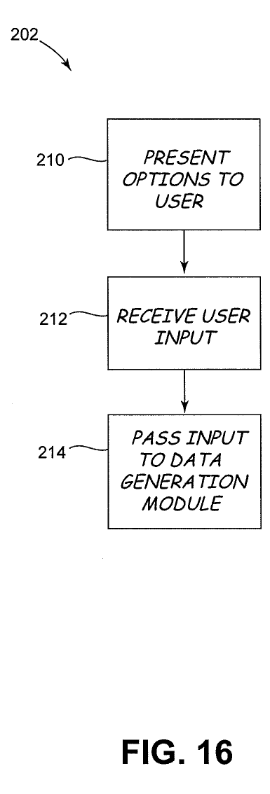

FIG. 16 is a flow diagram illustrating an exemplary embodiment of operation 202 for generating a user interface. Operation 202 is, for example, performed by a user interface module (e.g., user interface module 106 shown in FIG. 1). Operation 202 includes operation 210 during which options are presented to a user, operation 212 during which input is received from the user, and operation 214, during which the user input is passed to data generation module 108.

Operation 210 is an operation that displays a user interface to a user. In one embodiment, operation 210 is performed by a web browser that displays a web page to the user. The web page includes a set of options for a custom software application. Alternatively, operation 210 is performed by a software application. The software application displays on a display a user interface including a set of options for a custom software application. Alternatively, operation 210 is performed by a software application that generates audio to a user through a speaker. The audio includes a set of options for a custom software application. Alternatively, any other user interface can be used to convey a set of options to the user.

Operation 212 is an operation that receives input from the user based on the user interface presented in operation 210. In one example, operation 212 receives user input through a web browser displaying a web page. The web page (such as presented in operation 210) includes buttons, selection boxes, radio buttons, text fields, and the like associated with the options presented in operation 210. The user can select from the buttons, selection boxes, and radio buttons and enter text into text fields to define the desired operation of a custom software application. Alternatively, a software application receives the user input by enabling the user to select from buttons, selection boxes, radio buttons, and enter text into text fields to define the desired operation of a custom software application. Alternatively, a software application receives the user input by processing audio sounds received from the voice of the user.

Operation 214 is an operation that passes the user input to the data generation module. After a user has completed making his or her selections from the user interface, the user indicates that input has been completed, such as by selecting a “submit” or “run” button on the user interface. Alternatively, a software application determines that the user has completed input by receiving an audio “submit” or “run” command from the user.

After the user input has been completed, it is passed to the data generation module (e.g., data generation module 108 shown in FIG. 1). In one embodiment, passing of user input involves sending user input to a web server using HTTP, SSL protocol, or TLS protocol. Alternatively, passing of user input involves passing the input within a software application to a subroutine.

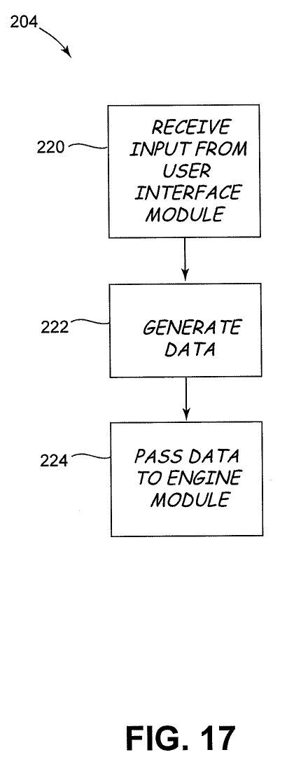

FIG. 17 is a flow diagram illustrating operation 204 for generating data. In one example, operation 204 is performed by a data generation module (e.g., data generation module 108 shown in FIG. 1). Operation 204 includes operation 220 during which input is received from a user interface module, operation 222 during which data is generated, and operation 224 during which data is passed to an engine module.

Operation 220 is an operation that receives the input from the user interface module. In one embodiment, user input is received via HTTP, SSL protocol, or TLS protocol, such as transmitted from a web browser across the Internet. In another embodiment, user input is received into a software application and is communicated to data generation module via the software application.

Operation 222 is an operation that generates data based upon the user input. In one example, data is a text-based markup language. Operation 222 converts the user input into the data, such as by listing with markup language each option selected by the user in the data. In one embodiment, data includes a set of objects and actions, and a set of attributes for the set of objects. The data fully describes the user's desired operation of the custom software application. Alternatively, operation 222 includes a combination of data and code. In this example, code is also generated to supplement the data. This is useful, for example, when a particular feature is not directly enabled by the engine, but is desired by a user. The code, such as C# programming language, is capable of being executed by a separate engine running in cooperation with the data engine module to generate the custom software application.

Operation 224 is an operation that passes the data generated in operation 222 to the engine module. Operation 224 passes the data over a network, such as the Internet, using a network transfer protocol such as HTTP, SSL protocol, or TLS protocol. Alternatively, data is stored on digital media and later accessed by the engine module. Alternatively, data is transmitted to engine module within a software application. Alternatively, any other method of data communication can be used.

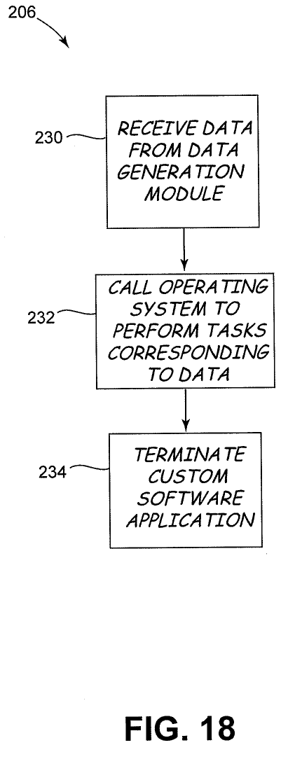

FIG. 18 is a flow diagram illustrating operation 206 for generating a custom software application. In one example, operation 206 is performed by an engine module (e.g., engine module 110 shown in FIG. 1). Operation 206 includes operation 230 during which data is received from data generation module (e.g., data generation module 108 shown in FIG. 1), operation 232 during which an operating system is called to perform tasks corresponding to the data, and operation 234 during which the custom software application is terminated.

Operation 230 is an operation that receives data, such as from a data generation module. In one example, operation 230 receives the data via a network communication protocol. In another example, operation 230 receives the data by opening a file stored on digital media. In another example, operation 230 receives the data from within a software application. Alternatively, another method of data transmission is used.

Operation 232 is an operation that calls the operating system to perform tasks corresponding to the data. In one example, operation 232 generates API calls that are sent to the operating system. The API calls correspond to a desired task of the custom software application. Therefore, the engine interacts with the operating system to generate the custom software application. Note that the system does not merely generate executable code that can later be executed, like a software compiler. Rather, during operation 232 the custom software application comes alive and begins to operate the tasks requested by the user.

Operation 234 terminates the operation of the custom software application after all desired tasks have been completed. In one embodiment, operation 234 occurs after the engine module has performed tasks corresponding to all of the data received. In another embodiment, operation 234 occurs after all desired tasks for the custom software application have been completed. In another embodiment, operation 234 occurs when a user provides an input indicating a desire that the custom software application be terminated. The input may include pressing a key on a keyboard, selecting a button on a user interface with the mouse, or speaking a particular word or phrase into a microphone.

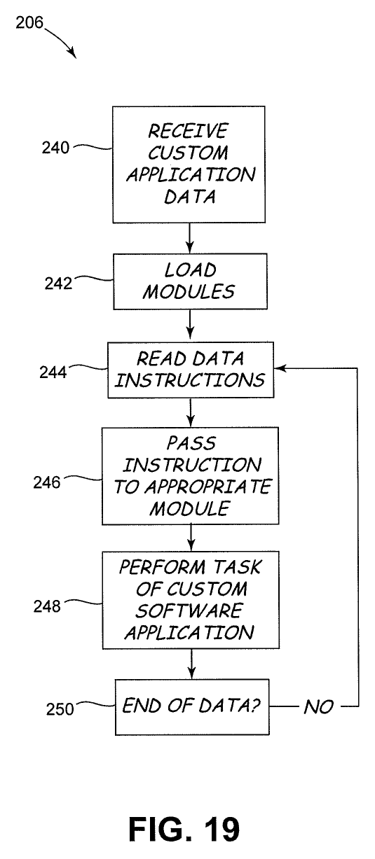

FIG. 19 is a flow diagram illustrating an alternate embodiment of operation 206 for generating a custom software application. In this embodiment, the engine module operates with additional modules to generate a custom software application, such as an interface display module (e.g., interface display module 122 shown in FIG. 6) and/or an application-specific module (e.g., application-specific module 124 shown in FIG. 6).

Operation 206 includes operation 240 during which custom software application data is received, operation 242 during which modules are loaded, operation 244 during which a data instruction is read, operation 246 during which the instruction is passed to the appropriate module, operation 248 during which a task of the custom software application is performed corresponding to the instruction, and operation 250 during which the custom software application is terminated once it reaches the end of the data.

Operation 240 is an operation which receives the custom software application data, such as from a data generation module. Data is received via a network communication protocol, or by opening a file on digital media, or by data transfer within a software application, or by any other method of transferring data.

Operation 242 loads any supplemental modules, such as an interface display module and/or one or more application-specific modules. These modules are loaded to assist the engine module (e.g., engine module 110 shown in FIG. 1) with the generation of the custom software application. For example, an interface display module is loaded to perform all tasks which interface with the user, such as displaying information on a computer monitor or display, or generating audio signals. Alternatively, or in addition, an application-specific module is loaded to perform application-specific functions.

Operation 244 reads one or more instructions from data. In this embodiment, data is processed sequentially, starting at the beginning and moving through the data to the end. In this example, the first data instruction is read first. The data instruction informs the engine module to perform a specified task. For example, the first data instruction is a request to generate an object having attributes. As another example, the data instruction is a request to perform an action, such as with a previously-generated object.

Operation 246 passes the data instruction to the appropriate module. For example, a data instruction including a request to display something on a computer screen is passed to the interface display module. Alternatively, a data instruction requesting a low-level processing task is passed to the kernel module. Alternatively, a data instruction requesting an application-specific task is passed to the application-specific module. Each module can then call other modules if needed to perform the requested task.

Operation 248 performs the task requested by the data instruction with one or more modules. For example, the engine module performs the task by calling the operating system with one or more direct API calls, requesting that the operating system perform the task identified by the data instruction. Alternatively, the interface display module generates a user interface display or communication as identified by the data instruction. Alternatively, an application-specific process, display, or communication is generated by the application-specific module, as requested by the data instruction.

Operation 250 then checks to see if additional data instructions are present in the data. If not, the custom software application terminates because it has completed all tasks identified by the data. If additional data instructions remain, the custom software application continues on to the next instruction. Specifically, operation 206 returns to operation 244 to read the next data instruction.

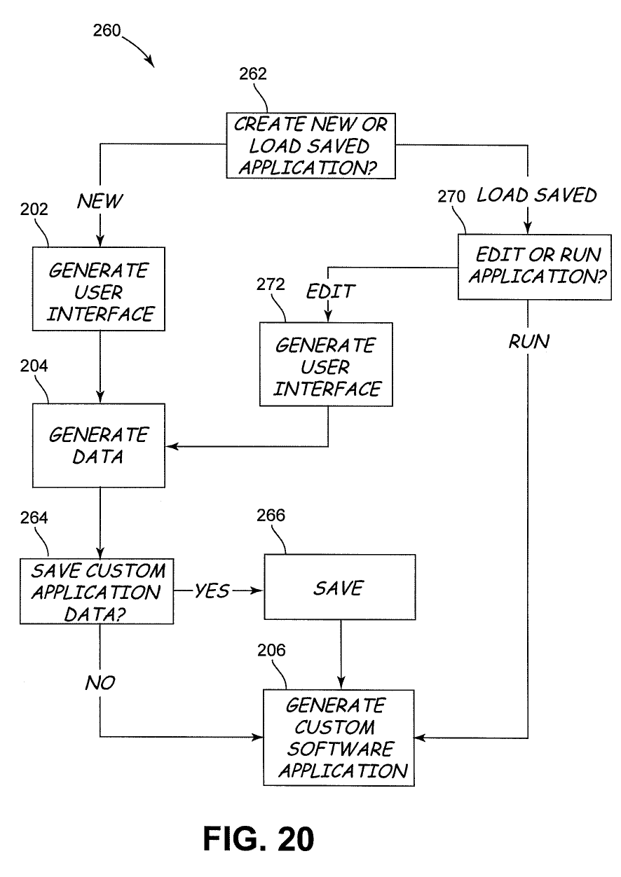

FIG. 20 is a flow diagram illustrating operation 260 during which data defining custom software applications can be saved to be later run or edited. Operation 260 includes method 200 (shown in FIG. 18) having operations 202, 204, and 206 but also includes additional steps enabling a user to save or edit data defining a custom software application.

Operation 260 includes operation 262 during which a user is prompted as to whether the user would like to create a new software application or load a saved software application, operation 202 during which a user interface is generated, operation 204 during which data is generated, operation 264 during which the user is prompted to save custom software application data, operation 266 during which custom software application data is saved, operation 206 during which the custom software application is generated, operation 270 during which the user is prompted to edit or run a saved custom software application, and operation 272 during which a user interface is generated containing pre-selected options.

Operation 260 begins with operation 262 which prompts the user to create a new software application or load a saved software application. If the user selects “create new” then operation 202 is performed. If the user selects “load saved” then operation 270 is performed.

To create a new software application, operation 202 is performed during which a user interface is generated. The user then provides input to select the desired options for the custom software application. Operation 204 if next performed to generate data based on the user input.

After generating data in operation 204, the user is prompted with operation 264 whether the user would like to save the custom software application. Although operation 264 prompts the user to save the custom software application, behind-the-scenes the operation is really asking whether the user would like to save the data defining the custom software application, as opposed to a binary executable software application. It is beneficial to save the data, because the data can then be subsequently edited and modified by the user, such as through the user interface module (e.g., user interface module 106 shown in FIG. 1), to reconfigure the operation of the custom software application. If the user desires to save the custom software application, operation 266 is performed to save the data to digital media. In one example, digital media is connected locally. In another example, digital media is a remote device connected across a network.

After saving the data in operation 266, or if the user does not want to save the data after prompted in operation 264, operation 206 is performed to generate the custom software application. Alternatively, an additional option is presented to the user to enable the user to exit before running the custom software application.

Returning to operation 262, if the user desires to load a saved custom software application, operation 270 is performed during which the user is prompted to edit or run a previously saved custom software application. If the user selects “edit,” then operation 272 is performed to generate a user interface, similar to operation 202. However, in operation 272, the user interface is displayed including the pre-selected options. In this way, the user does not have to start from scratch, but rather is enabled to modify the previously defined custom software application, such as to make minor modifications. After the user has finished modifying the options through the user interface of operation 272, operation 260 continues as previously described with operations 204, 264, 266, and 206.

At operation 270, the user is also given the option to run a saved software application. If this option is chosen, the data is loaded and passed to the engine module where it is run at operation 206. This saves the user time by enabling the user to bypass the user interface module and data generation module for a previously defined custom software application if no changes are necessary.

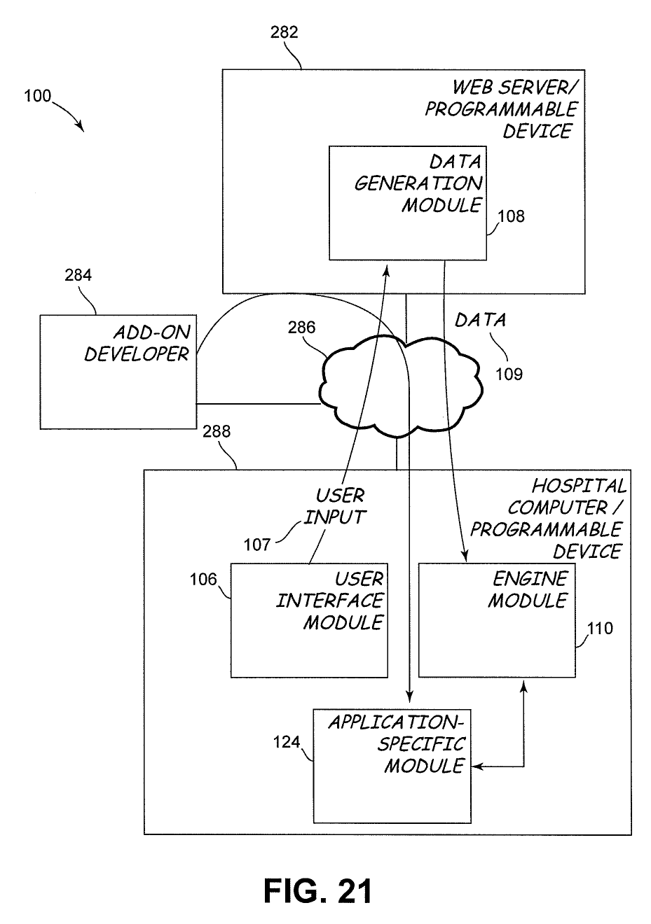

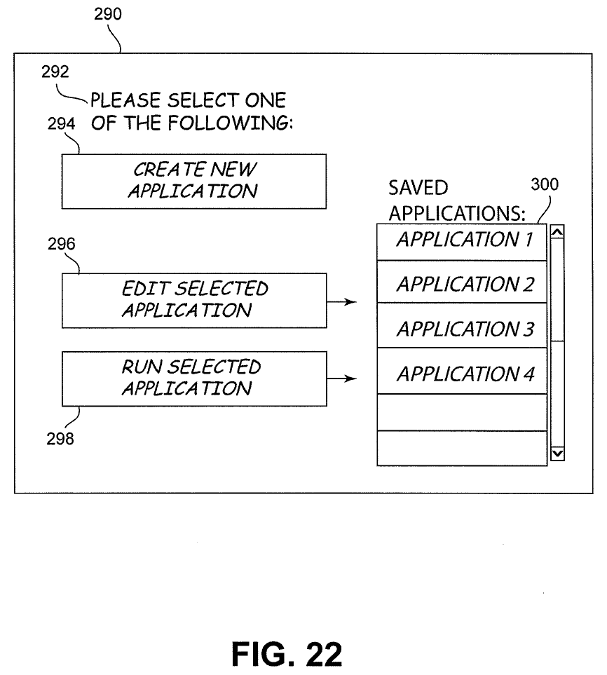

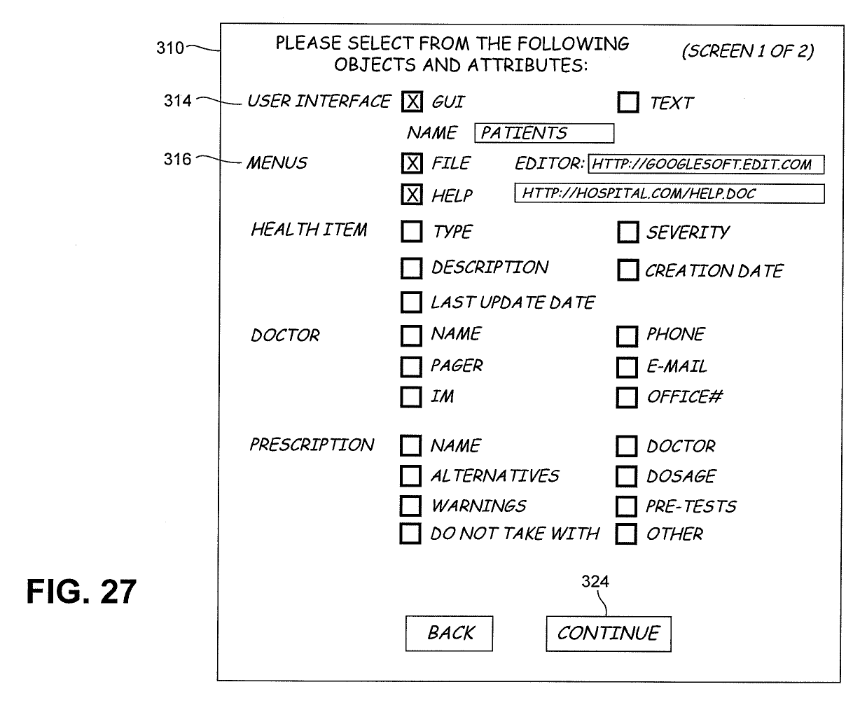

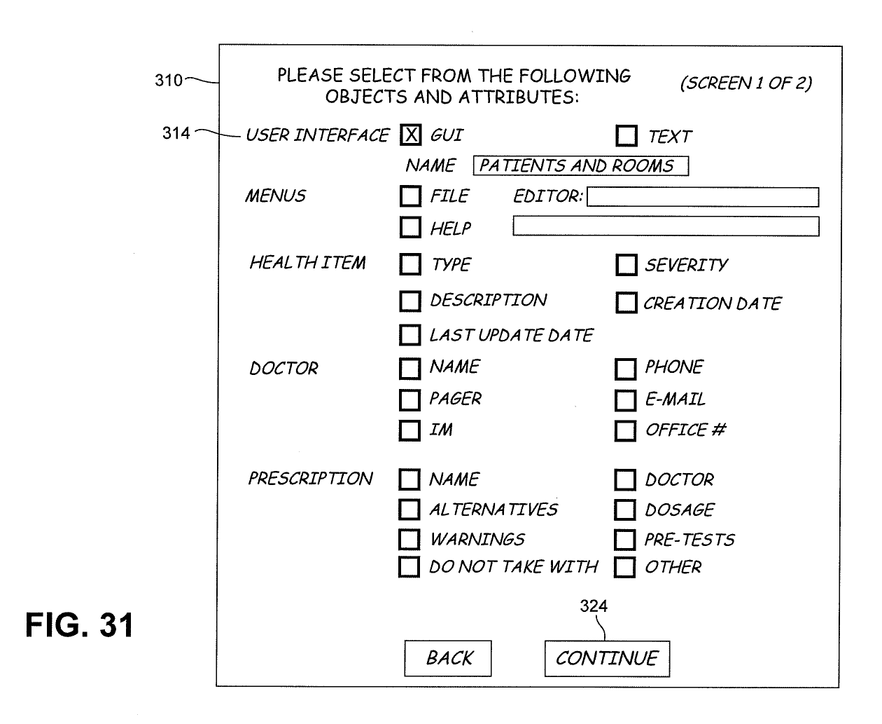

Examples will now be provided with reference to an application-specific embodiment of system 100. In these examples, a hospital administrator desires to generate a custom software application to perform hospital-specific tasks. A system configuration for the examples is illustrated in FIG. 21. Each of the examples begins with a user interface screen shown in FIG. 22. The first example is further illustrated in FIGS. 20-23. The second example is further illustrated in FIGS. 27-31. The third example is further illustrated in FIGS. 31-34.

FIG. 21 is block diagram illustrating an embodiment of system 100. System 100 is similar to the embodiment illustrated and described with reference to FIG. 14, and includes web server 282, add-on developer 284, network 286, and computer 288. Web server 282 is a web server operated by the hospital. Computer 288 is a computer, such as at the front desk of the hospital. In this example, the hospital administrator desires to use computer 288 to define and run a custom software application. Add-on developer 284 is a distributor of application-specific module 124 designed specifically for hospital administration. Web server 282, add-on developer 284, and computer 288 are all connected to network 286, such as the Internet.

In this example, the hospital has setup web server 282. All hospital administrators are given access to web server 282 to enable them to generate custom software applications to assist in hospital administration. Alternatively, web server 282 can be setup and maintained by add-on developer 284.

To setup computer 288, user interface module 106, engine module 110, and application-specific module 124 are all installed on computer 288. User interface module 106 is, for example, a web browser that is installed onto computer 288. Engine module 110 is installed by downloading engine module 110 from web server 282 that is setup to distribute engine module 110. Alternatively engine module 110 can be downloaded from add-on developer 284, or installed from digital media such as a CD-ROM. Application-specific module 124 is downloaded from add-on developer 284. Alternatively, web server 282 can also be setup to distribute application-specific module 124 to computer 288.

Web server 282 is setup by configuring it as a web server for distribution of a web site across network 286. In addition, data generation module 108 is installed on web server 282, such as by downloading data generation module 108 from add-on developer 284.

FIG. 22 is an example screen shot of user interface 290. The following examples all begin with user interface 290, generated by user interface module 106, such as a web browser displaying a web page from web server 282. User interface 290 includes prompt 292, create new application button 294, edit selected application button 296, run selected application button 298, and list of saved applications 300.

User interface 290 prompts the user to create a new custom software application or to load a previously saved application, using prompt 292. If the user desires to create a new application, the user selects create new application button 294. If the user desires to load a previously saved application, the user selects the saved application from list of saved application 300. After selecting the saved application, the user then selects edit selected application button 296 to edit the application, or run selected application button 298 to run the selected application.

For these examples, the hospital administrator desires to create a new custom software application. As a result, the hospital administrator selects create new application button 294.

In the first example, further illustrated and described with reference to FIGS. 20-23, a hospital administrator desires to create a custom software application to keep track of what hospital rooms are occupied and what hospital rooms are vacant. More particularly, the hospital administrator wants a system that will assist in assigning rooms to new patients and in freeing rooms after a patient leaves.

In this example, web server 282 (shown in FIG. 21) generates a web page that is then displayed by user interface module 106, such as a web browser. Web server 282 generates the web page by first reading a data schema file received from add-on developer 184, and then transmitting the web page to user interface module 106. An example of the data schema file is as follows:

### Example Data Schema File

```
<DefineObject HealthItem HealthItemID, Type = disease, preventative;
Severity=high, medium, low, Description, CreationDate, LastUpdateDate
End HealthItem>
<DefineObject Doctor DoctorID, Name, Phone, Pager, E-Mail, IM,
Office# End Doctor>
<DefineObject Prescription PrescriptionID, Name, DoctorID, Alternatives,
Dosage, Warnings, Pre-Tests, DoNotTakeWithList, Other, File, Help
End Prescription>
<DefineObject Condition MedID, DoctorList, Date, Diagnosed Date,
PrescriptionList, HealthItemList
End Condition>
<DefineObject Patient PatientID, Name, gender, ListOfConditions,
birth date, MainDoctor=DoctorID, notes, warnings
End Patient>
<DefineAction PatientAction>
    <List>
    <Add>
    <Delete>
    <List By Type>
<End PatientAction>
<DefineObject Room RoomID, name, number, size(x,y,z), creation
date, free, LastOccupiedDate
End Room>
<DefineAction RoomAction>
    <Select PatientID, RoomID>
    <Free RoomID>
    <Block RoomID>
    <Maintenance RoomID>
    <ListInUse>
    <ListAvailable>
    <ListBlocked>
    <ListAll>
<End RoomAction>
```

The data schema file includes a list of all objects, attributes, and actions that are available through application-specific module 124 for the generation of a custom software application.

The data schema file is written in a text-based markup language. In this example, the object or action is first identified with a “Define” command. For example, the first object “HealthItem” begins with the define command “<DefineObject HealthItem HealthItemID.” Objects are further defined by a list of attributes that follow the define command. For example, the “HealthItem” object includes the attributes list of “Type=disease, preventative; Severity=high, medium, low, Description, CreationDate, LastUpdateDate.” As shown, attributes can be further defined by listing all possible values. Finally, an object is completed with an “End” command, such as “End HealthItem>.” Actions are similarly defined, except that after being defined, actions are followed by a list of actions, rather than a list of attributes. The list of actions includes the objects required for that action. The data schema file is alternatively defined using XML or any other text-based markup language.

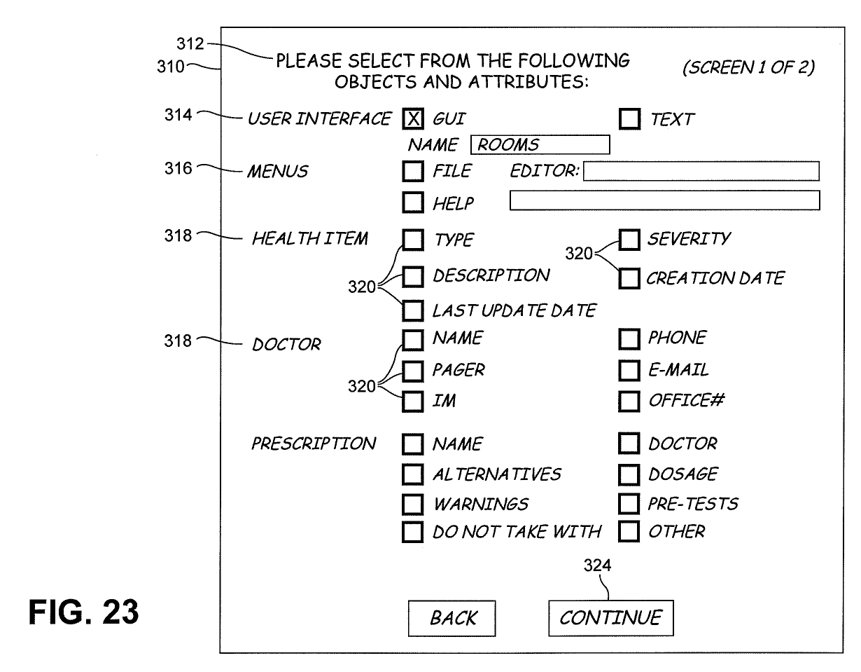

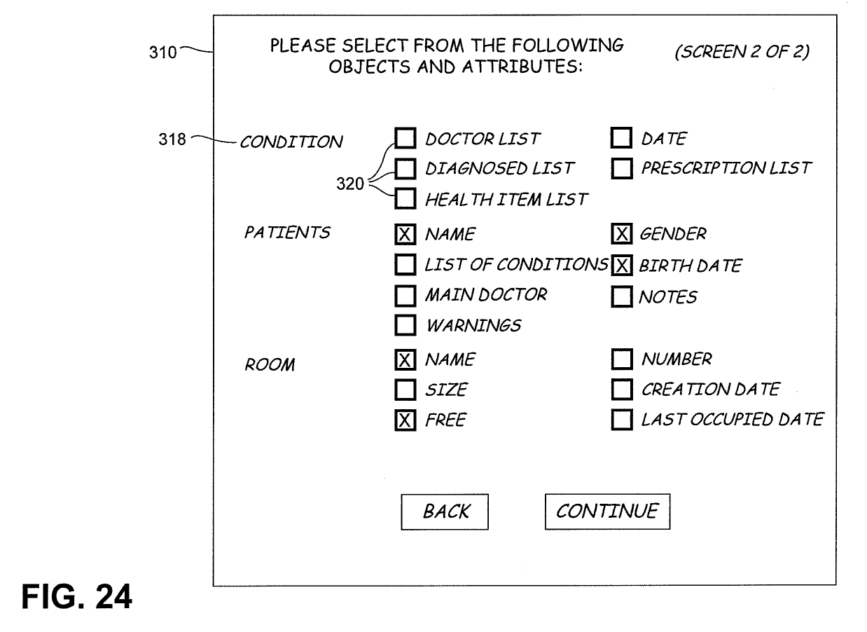

FIGS. 23 and 24 illustrate user interface 310 as displayed by user interface module 106 to display of a list of options based on the data schema file. User interface 310 includes prompt 312, general user interface options 314, general menu options 316, list of objects 318, and list of attributes 320.

User interface 310 prompts the user to select from the available objects and attributes with prompt 312. General user interface options 314 are displayed to determine whether the user desires for the custom software application to have a graphical user interface or a text-based user interface, and also to determine the name for the custom software application. General menu options 316 are also presented to the user to determine whether the user desires the ability to open a file with the custom software application (and if so, the name of the default editor), and whether the user desires the ability to view a help file (and if so, the location of the help file).

Next, user interface 310 displays the list of available objects 318 and attributes 320 for application-specific module 124. As defined by the example data schema presented above, objects 318 include HealthItem, Doctor, Prescription, Condition, Patients, and Room. Each of the objects 318 include a list of attributes 320. For example, the HealthItem object includes the attributes of type, severity, description, creation date, and last update date. Attributes 320 are displayed adjacent the object 318 to which they relate.

The user interface includes the capability to break up a large list of objects and attributes into multiple screens if necessary. FIGS. 20 and 21 include a first screen and a second screen, respectively, which display the full list of objects 318 and attributes 320. Navigation buttons are automatically generated including continue button 324.

In this example, the hospital administrator selects the objects that will be needed for the custom software application. For example, the hospital administrator selects a GUI from general user interface options 314 to provide a graphical user interface for the custom software application. The hospital administrator also types in the name of the custom software application as “Rooms” in the name field of general user interface options 314. None of the other objects of FIG. 23 are desired by the hospital administrator, and so the objects and attributes are left unselected. Continue button 324 is then selected to display the second page of user interface 310.

FIG. 24 illustrates a second screen of user interface 310. User interface 310 includes a list of the remaining objects 318 and attributes 320. On this screen, the hospital administrator desires to use the patients object 318, and specifically the name, gender, and birth date attributes 320 of the patients object 318. As will be shown, the patient object along with the selected attributes enable the entering or display of patient information including the patient's name, gender, and birth date. In addition, the hospital administrator desires to use the room object 318, and specifically the name and free attributes 320 of the room object 318. As will be shown, the room object along with the selected attributes enable the display of room information including the name of the room and a list of what rooms are vacant.

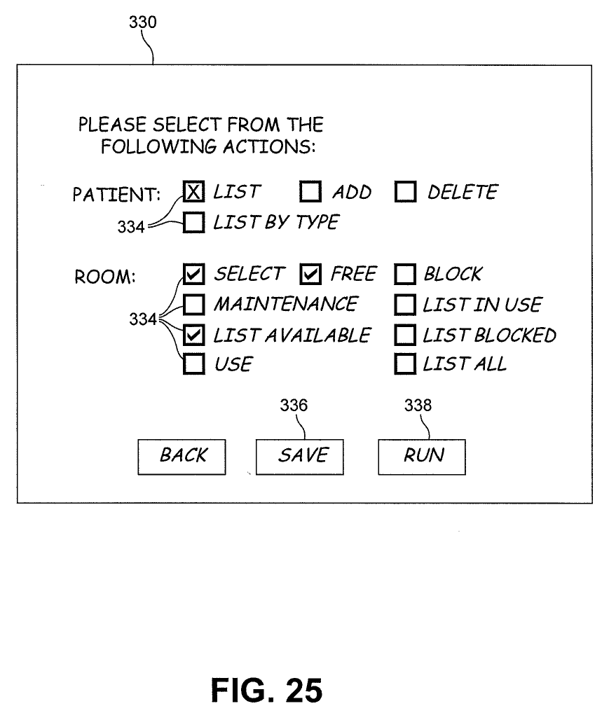

FIG. 25 illustrates user interface 330 as displayed by user interface module 106 for the display of a list of actions based on the data schema file. After presenting the available objects and attributes, user interface module 106 displays a list of available actions on user interface 330. User interface 330 includes a list of objects 318, and a list of available actions associated with those objects 318.

In this hospital administration example, and as shown in FIGS. 20 and 21 above, the hospital administrator selected the patients object 318 and the room object 318, by selecting attributes 320 associated with those objects. Next, user interface 330 displays the available actions associated with the selected objects. Therefore, the patient and room objects 318 are displayed.

For each object, user interface 330 displays a list of actions associated with that object, as defined by the data schema file, such as shown above. In this example, the data schema file defines the available patient actions as List, Add, Delete, and List by Type, and the available room actions as Select, Free, Block, Maintenance, List In Use, List Available, List Blocked, and List All.

Of the available actions, the hospital administrator does not desire to use any of the patient actions 334, but desires to use the select and list available room actions 334. Therefore, the hospital administrator selects those actions.

At this point the hospital administrator has now defined all desired features of the custom software application. User interface 330 gives the hospital administrator the option to save the custom software application by selecting save button 336 or run the custom software application by selecting run button 338. In this example, the hospital administrator desires to run the application without saving it, and selects run button 338.

In an alternate embodiment, a test is performed on the selected objects, attributes, and actions to ensure that rules have been followed. For example, if an action requires two specific objects, a test can be performed to ensure that the user has selected the required objects. If the user has not selected those objects, an error is displayed informing the user that the action requires a particular set of objects. Any other rules can also be defined.

After the user selects run button 338, the selections made through user interfaces 310 and 330 are sent from user interface module 106 back to web server 282 (shown in FIG. 21) and specifically to data generation module 108. In one embodiment, the client computer 288 returns user input to web server 282 in the form of an HTTP get or post message including the user input in the body of the message. This message is one example of the user input 107 shown in FIG. 3. Data generation module 108 then parses the user input and generates data based on the selections made by the hospital administrator. Data generation module 108 sends the data back to computer 288 and specifically to engine module 110. An example of data 109 generated by data generation module 108 is as follows:

### Example Data

```
<DefineUserInterface UserInterfaceID gui = “yes”, text = “no”,
title = “Rooms”>
    <RoomAction>
<End UserInterface>
<DefineObject Patient PatientID, Name = “yes”, gender = “yes”,
ListOfConditions = “no”, birth date = “yes”, main doctor = “no”,
notes = “no”, warnings = “no”
End Patient>
<DefineObject Room RoomID, name = “yes”, number = “no”,
size(x,y,z) = “no”, creation date = “no”, free = “yes”,
LastOccupiedDate = “no”
End Room>
<DefineAction RoomAction>
    <Select PatientID, RoomID>
    <Free RoomID>
    <ListAvailable>
<End RoomAction>
```

The data generated by data generation module 108 includes a list of all objects, attributes, and actions selected by the user to define the custom software application. The data is sent from data generation module 108 to engine module 110 which generates the custom software application.

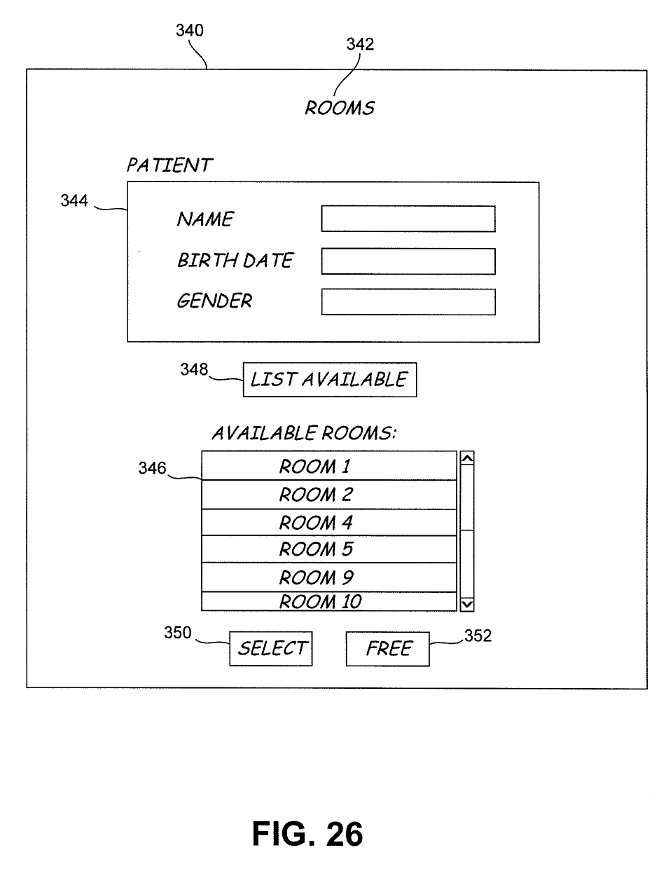

FIG. 26 is a screen shot of user interface 340 of custom software application 102. Once data is received from data generation module 108, the custom software application 102 is run by engine module 110.

In this example, engine module 110 (working in cooperation with application-specific module 124) receives the example data 109 described above. Engine module 110 reads data 109 and generates the custom software application defined by the data. For example, the custom software application first generates a user interface having a graphical user interface (GUI) and titled “Rooms” as shown in FIG. 26. It next generates “patients” objects and “rooms” objects having the defined attributes. Finally, it generates a display associated with the objects, attributes, and actions.

User interface 340 first displays the application name 342 at the top. User interface 340 also includes patient display 344, available rooms display 346, list available button 348, select button 350, and free button 352.

Patient display 344 includes the three patient attributes requested by the user, including name, birth date, and gender. The patient display 344 enables the name of a patient to be input, so that the patient can be assigned to an available room. Available rooms display 346 provides a list of all available rooms. To update the list of available rooms, the user selects list available button 348. The names of each available room are then displayed.

The custom software application is now capable of operating to perform the tasks desired by the hospital administrator. When a new patient comes in, the hospital administrator enters the patient's name, birth date, and gender into patient display 344. Next, the hospital administrator selects list available button 348 to update available rooms display 346. The hospital administrator selects the desired room and chooses select button 350 to assign the room to the patient identified in patient display 344. When the patient leaves, and the room is again available, the hospital administrator types in the patient's name, birth date, and gender, and selects free button 352 to make the room available for another patient.

A second hospital administration example is illustrated and described with reference to FIGS. 27-30. In this example a hospital administrator desires a custom software application to display all patient records maintained by the hospital.

FIG. 27 is a screen shot of a first screen of user interface 310. After selecting create new application button 294 (e.g., create new application button 294 as shown in FIG. 22), the hospital administrator is presented with user interface 310 where the hospital administrator selects from the available options. For example, the hospital administrator selects a graphical user interface from general user interface options 314, and a file menu button and a help menu button from general menu options 316. The hospital administrator enters the location of a favorite file editor, and the address for the hospital help document to be associated with the buttons. No other objects or attributes are desired, and so the hospital administrator selects continue button 324.

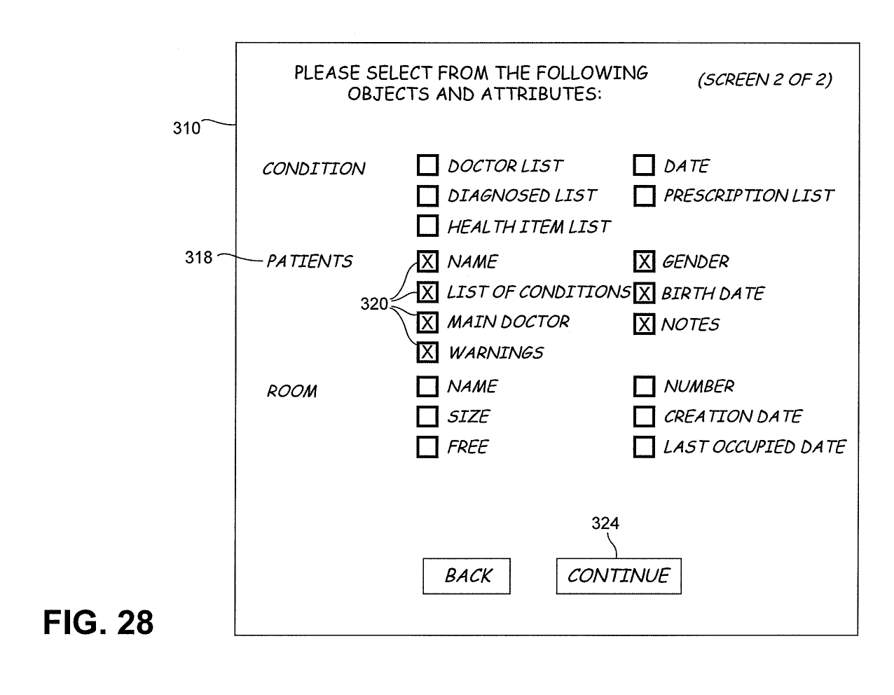

FIG. 28 is a screen shot of a second screen of user interface 310. The remaining objects and attributes are displayed by the second screen of user interface 310, as shown in FIG. 28. Here, the hospital administrator desires to have access to all known information about patients, and so the hospital administrator selects all available attributes 320 of patients object 318. Having selected all desired objects and attributes, the hospital administrator selects continue button 324 to continue.

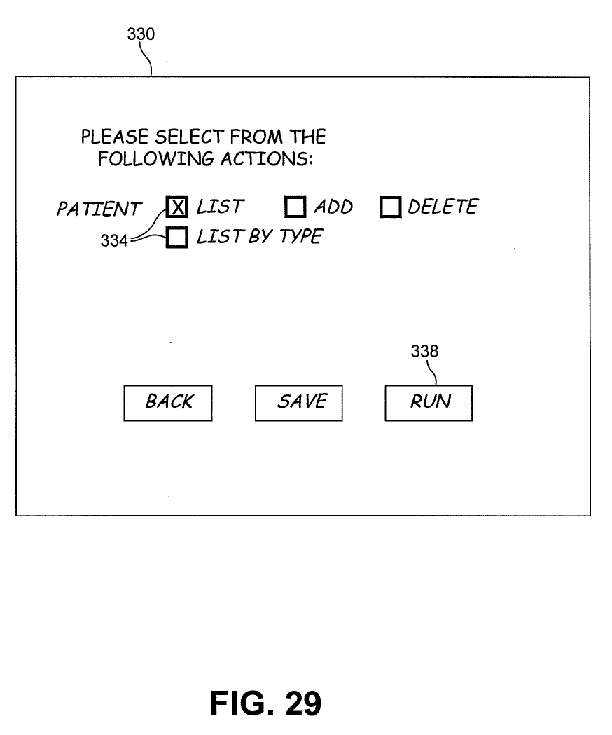

FIG. 29 is a screen shot of user interface 330 displaying the available actions associated with the selected objects. As can be seen, by presenting the list of actions after the list of objects, the system simplifies the amount of data by displaying only those actions associated with selected objects. Actions associated with unselected objects are not displayed. In this example, only the patient object was selected, and therefore only the patient actions are displayed. From the available patient actions, the hospital administrator desires only to list the patients, and therefore selects list action 334.

Having finished selecting the desired options for the custom software application, the hospital administrator selects run button 338 to run the custom software application. Before the application is run, however, the input is sent to data generation module 108 (shown in FIG. 21) which generates data as follows:

### Example Data

```
<DefineUserInterface UserInterfaceID gui = “yes”, text = “no”,
title = “Patients”>
    <PatientAction>
<End UserInterface>
<DefineObject Menu MenuID, file = “yes”, editor =
“http://googlesoft.edit.com”, help = “yes”, HelpPath =
“http://hospital.com/help.doc” End Menu>
<DefineObject Patient PatientID, Name = “yes”, gender = “yes”,
ListOfConditions = “yes”, birth date = “yes”, main doctor = “yes”,
notes = “yes”, warnings = “yes”
End Patient>
<DefineAction PatientAction>
    <List>
<End PatientAction>
```

The data is received by engine module 110 (operating in cooperation with application-specific module 124), which generates the custom software application defined by the data.

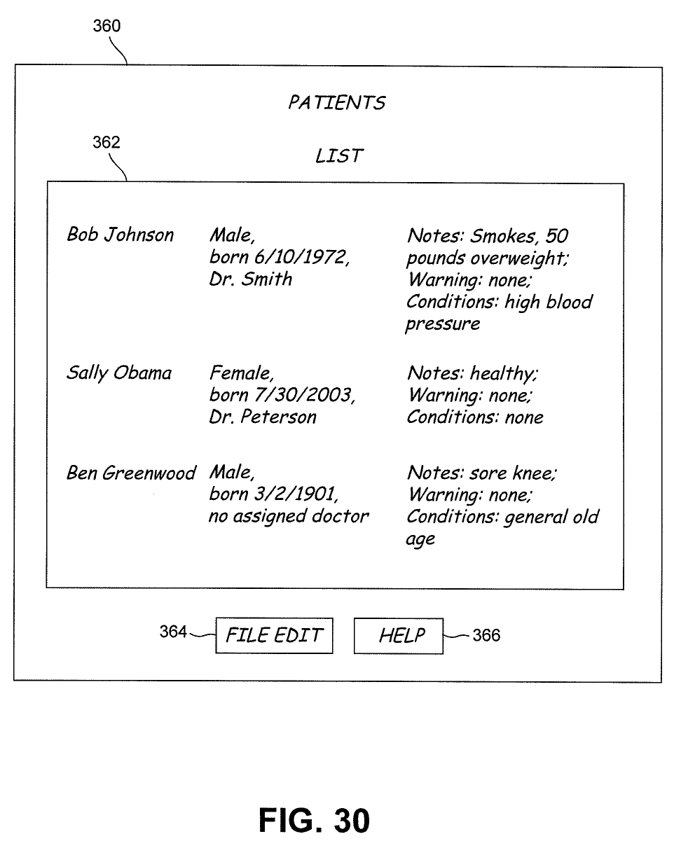

FIG. 30 is a screen shot of user interface 360 of custom software application 102. custom software application 102, generated by engine module 110 in cooperation with application-specific module 124, displays the list of patients 362 including the associated patient information. In this example, only three names are listed for exemplary purposes. User interface 360 also includes file edit button 364 and help button 366. Selecting file edit button 364 opens the editor defined by the hospital administrator to enable the hospital administrator to edit the hospital records. Selecting help button 366 opens the associated hospital help file, to display help topics to the user.

A third hospital administration example is illustrated in FIGS. 31-34. In this example a hospital administrator desires a custom software application to display all patient records maintained by the hospital and all rooms in the hospital.

FIG. 31 is a screen shot of a first screen of user interface 310. After selecting create new application button 294 (e.g., create new application button 294 as shown in FIG. 22), the hospital administrator is presented with user interface 310 where the hospital administrator selects from the available options. For example, the hospital administrator selects a graphical user interface from general user interface options 314. No other objects or attributes are desired from this screen, and so the hospital administrator selects continue button 324.

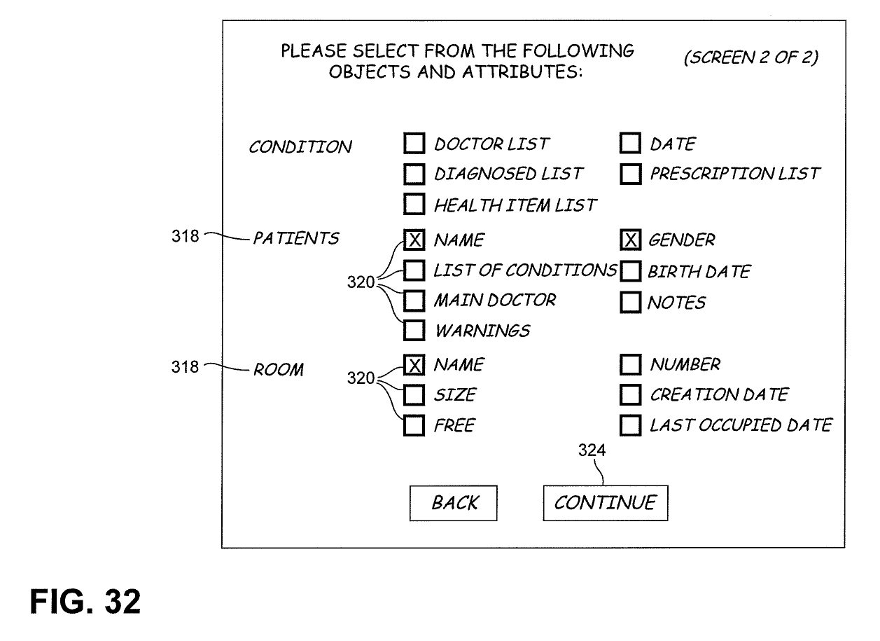

FIG. 32 is a screen shot of a second screen of user interface 310. The remaining objects and attributes are displayed by the second screen of user interface 310, as shown in FIG. 32. Here, the hospital administrator desires to have a list of all patients, including their names and gender, and a list of all rooms by name. The hospital administrator makes the appropriate selections, and then selects continue button 324 to continue.

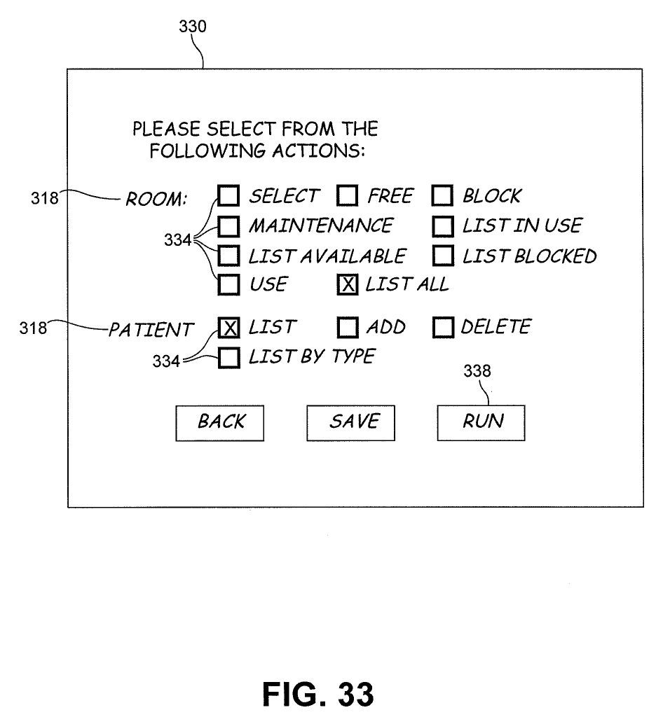

FIG. 33 is a screen shot of user interface 330 displaying the available actions associated with the selected objects. In this example, both the patient object and the rooms object were selected, and therefore the actions associated with the room and patient objects are displayed. The hospital administrator selects List All action 334 associated with the room object 318, and List action 334 associated with the patient object 318.

Having finished selecting the desired options for the custom software application, the hospital administrator selects run button 338 to run the custom software application. Before the application is run, however, the input is sent to data generation module 108 (shown in FIG. 21) which generates data as follows:

### Example Data

```
<DefineUserInterface UserInterfaceID gui = “yes”, text = “no”,
title = “Patients and Rooms”>
    <PatientAction>
    <RoomAction>
<End UserInterface>
<DefineObject Room RoomID, name = “yes”, number = “no”,
size(x,y,z) = “no”, creation date = “no”, free = “no”,
LastOccupiedDate = “no”
End Room>
<DefineAction RoomAction>
    <List All>
<End RoomAction>
<DefineObject Patient PatientID, Name = “yes”, gender = “yes”,
ListOfConditions = “yes”, birth date = “yes”, main doctor = “yes”,
notes = “yes”, warnings = “yes”
End Patient>
<DefineAction PatientAction>
    <List>
<End PatientAction>
```

The data is received by engine module 110 (operating in cooperation with application-specific module 124), which generates the custom software application defined by the data.

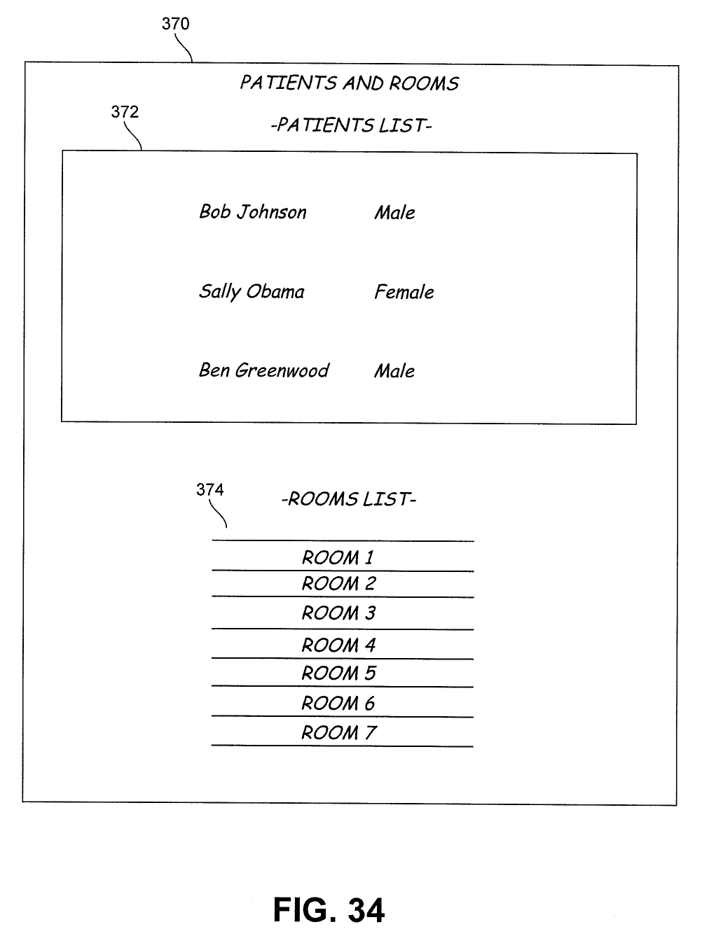

FIG. 34 is a screen shot of user interface 370 of the custom software application 102. Custom software application 102, generated by engine module 110 in cooperation with application-specific module 124, displays user interface 370 including the list of patients 372 and list of rooms 374. The list of patients 372 includes the name and gender of each of the patients, and the list of rooms 374 includes the name of each of the rooms. No other action was requested, and therefore once the user has completed reviewing the information, the custom software application terminates.

These examples illustrate just one possible application-specific embodiment of system 100. It is recognized that a wide variety of possible alternate application-specific embodiments will also benefit from system 100. In addition, an alternate embodiment does not require an application-specific module per se, but rather is equipped with a standard add-on module that is intended for use by all users. Such a module provides features and functionality that are useful to most or all users of system 100.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

The claimed invention is:

1. A system for generating a custom software application, the system comprising:
an interface module programmed to generate an interface configured to receive input;
a data generation module programmed to generate data defining operation of a custom software application in response to the input received through the interface; and
an engine module programmed to generate the custom software application in response to the data generated by the data generation module, the custom software application being executable by a programmable device.

2. The system of claim 1 wherein the programmable device is selected from the group comprising: a computer, a handheld computer, a cell phone, an automobile, and a personal digital assistant.

3. The system of claim 1, wherein the interface module, data generation module, and engine module are executed by a single programmable device.

4. The system of claim 1, wherein the interface module, data generation module, and programmable module are each executed by separate programmable devices.

5. The system of claim 1, wherein the data generation module is executed by a first programmable device and the engine module is executed by a second programmable device.

6. The system of claim 5, wherein the first programmable device is located remotely from the second programmable device.

7. The system of claim 6, wherein the first and second programmable devices communicate via a network and the network is selected from the group comprising: the Internet, an Intranet, a local area network, a wireless network, a satellite radio network, and an infrared network.

8. The system of claim 5, wherein the interface module is a web browser.

9. The system of claim 1, wherein the engine module is executed by a first programmable device and the custom software application is run on a second programmable device.

10. The system of claim 9, wherein the custom software application is implemented through remote API calls from the engine module to the second programmable device.

11. The system of claim 1, wherein the engine module is further programmed to communicate with an operating system so that the custom software application is compatible with the operating system.

12. The system of claim 11, wherein the engine module is programmed to call the operating system to perform tasks corresponding to the data.

13. The system of claim 12, wherein the engine module is programmed to make at least one API call to the operating system to invoke an operating system service corresponding to the data.

14. The system of claim 13 wherein the operating system service is selected from the group comprising: a file system service, a user interface service, a memory service, a repository service, a printing service, a security service, a communication service, a performance monitoring service, and a logging service.

15. The system of claim 12 wherein the engine module is programmed to make calls to the operating system based solely on the data.

16. The system of claim 12 wherein the engine module is programmed to make calls to the operating system based on the data or based on a separate set of program code.

17. The system of claim 1, further comprising an application-specific module in communication with the engine module, the application-specific module dedicated to generating a specific type of custom software application.

18. The system of claim 17, wherein the application-specific module is dedicated to generating the specific type of custom software application selected from the group comprising: computer security, anti-malware, compliance, systems administration, hospital administration, and data management.

19. The system of claim 1, further comprising an interface display module programmed to generate an interface for the custom software application.

20. The system of claim 19 wherein the interface display module programmed to generate the interface for the custom software application generates the interface based on the data.

21. The system of claim 1, wherein the data comprises an ordered and structured language.

22. The system of claim 21, wherein the ordered and structured language is represented by notations selected from the group comprising text, ASCII, and UTF-8.

23. The system of claim 21, wherein the ordered and structured language is a markup language.

24. The system of claim 23, wherein the markup language is an extensible markup language (XML).

25. The system of claim 1, wherein the interface module is a user interface module programmed to receive input from a user.

26. A method of generating a custom software application, the method comprising:
generating an interface configured to receive input;
generating data, the data defining operation of a custom software application in response to the input received through the interface; and
generating a custom software application in response to the data, the custom software application being executable by a programmable device.

27. The method of claim 26, wherein generating the interface, generating the data, and generating the custom software application are all performed on a single programmable device.

28. The method of claim 26, wherein generating the interface, generating data, and generating the custom software application are each performed by separate programmable devices.

29. The method of claim 26, wherein generating data is performed by a first programmable device and generating the custom software application is performed by a second programmable device.

30. The method of claim 29, further comprising communicating the data from the first programmable device to the second programmable device across a network.

31. The method of claim 26, wherein generating the interface is performed by a web browser.

32. The method of claim 26, wherein generating the custom software application further comprises communicating with an operating system so that the custom software application is compatible with the operating system.

33. The method of claim 26, wherein generating the custom software application comprises calling an operating system to perform tasks corresponding to the data.

34. The method of claim 33, wherein calling the operating system comprises making at least one API call to the operating system to invoke an operating system service corresponding to the data.

35. The method of claim 34, wherein the operating system service is selected from the group comprising: a file system service, a user interface support service, a memory service, a repository service, a printing service, a security service, a communication service, a performance monitoring service, and a logging service.

36. The method of claim 33, wherein calls made by the operating system are based solely on the data.

37. The method of claim 33, wherein calls made by the operating system are based on the data or based on a separate set of program code.

38. The method of claim 26, wherein generating the custom software application comprises generating a specific type of custom software application using an application-specific module in communication with the engine module.

39. The method of claim 38, wherein the specific type of custom software application is selected from the group comprising: computer security, anti-malware, compliance, systems administrator, hospital administrator, and data management.

40. The method of claim 26, further comprising generating a user interface display for the custom software application.

41. The method of claim 40, wherein the user interface display is generated based on the data.

42. The method of claim 26, wherein generating data comprises generating data from an ordered and structured language.

43. The method of claim 42, wherein generating data further comprises generating data represented by notations selected from the group comprising text, ASCII, and UTF-8.

44. The method of claim 42, wherein generating data further comprises generating data from a markup language.

45. The method of claim 44, wherein generating data from a markup language further comprises generating data from an extensible markup language.

46. The method of claim 26, wherein generating the interface comprises generating a user interface configured to receive input from a user.

47. A method of generating data defining a custom software application, the method comprising:
receiving user input;
determining a text-based data command that corresponds with the user input; and
storing the text-based data command in a data file, the data file being executable to generate a custom software application.

48. The method of claim 47, wherein receiving user input comprises receiving user input corresponding to a selected object on a graphical user interface.

49. The method of claim 47, wherein determining a text-based data command comprises:
locating the user input in the look-up table; and
identifying the data command in the look-up table, the data command being associated with the user input in the look-up table.

50. A method of executing a custom software application, the method comprising:
receiving a data file including at least one text-based data command defining the custom software application;
determining a task associated with the text-based data command; and
performing the task.

51. The method of claim 50, wherein determining the task comprises:
locating the text-based data command in a look-up table; and
identifying the task in the look-up table, the task being associated with the text-based data command in the look-up table.

52. The method of claim 50, wherein the task identifies an operating system call, and wherein performing the task comprises sending the operating system call to an operating system.

53. The method of claim 52, wherein the operating system call is an Application Programming Interface call.
